(19) United States
(12) Patent Application Publication
(10) Pub. No.: US 2024/0232910 A9
(43) Pub. Date: Jul. 11, 2024

(54) SUSTAINABLE AVIATION FUEL BLOCKCHAIN REGISTRY

(71) Applicant: 4AIR, LLC, Cleveland, OH (US)

(72) Inventors: Kennedy Ricci, Cleveland, OH (US); Nancy Bsales, Cleveland, OH (US)

(73) Assignee: 4AIR, LLC, Cleveland, OH (US)

(21) Appl. No.: 18/383,801

(22) Filed: Oct. 25, 2023

Related U.S. Application Data
(60) Provisional application No. 63/419,251, filed on Oct. 25, 2022.

(51) Int. Cl. G06Q 30/018; G06Q 40/04

(52) U.S. Cl. CPC G06Q 30/018; G06Q 40/04

(57) ABSTRACT

Presented herein are systems and method for blockchain based tracking resource production and sustainability. A producer computer associated with a blockchain may receive production information indicating an amount of a resource produced, a batch identifier for the resource produced, and a plurality of wallet identifiers for a corresponding plurality of resource recipients. The produce computer may determine a number of blocks for the blockchain to generate for representing a unit of the resource produced of the amount of resource produced. The producer computer may generate a plurality of blocks on the blockchain according to the number of blocks and using the production information. The plurality of blocks may include a plurality of sets of blocks for a corresponding resource recipient of the plurality of resource recipients. Each block in the set of blocks for the corresponding resource recipient including a wallet identifier for the resource recipient.

### CROSS-REFERENCE TO RELATED APPLICATION

This application claims priority to U.S. Provisional Application No. 63/419,251, entitled “Sustainable Aviation Fuel Blockchain Registry,” filed Oct. 25, 2022, which is incorporated by reference in its entirety.

### TECHNICAL FIELD

The present application generally relates to database management. In particular, the present application relates to blockchain-based tracking of resource consumption and environmental attributes.

### BACKGROUND

A supplier may deliver a resource (e.g., petroleum fuel, oil, coal, natural gas) consumed during industrial operations or machinery. For instance, the supplier delivers fuel or other resources delivered to a vehicle (e.g., aircraft) of a consumer entity (e.g., airline carrier) to power internal combustion engines when operational. Conventionally, the supplier or recipient entities manually compile records of the delivery of the fuel using various paperwork maintained by the supplier and the recipient entities. The data regarding the supply of fuel as recorded in the papers may be scanned and catalogued on a database if at all. There is, however, no way to provide an independent centralization of the data and proof of ownership or association with each record.

The manual compilation of these records may result in incomplete data and introduce a high level of error on the database. Moreover, the lack of centralization and proof of ownership may result in duplicate entries for the same delivery, and inability to verify the delivery of the fuel by the supplier to the consumer. There may also be difficulty to assess and evaluate the environmental impacts and other corollary effects associated with the consumption of the fuel. For example, multiple entities may make duplicative or redundant claims to the same volume of fuel and its associated attributes related to emission of carbon dioxide.

As a result, data records may include erroneous and/or incomplete data. The information in the records further includes or results in un-validated claims and may cause challenges in compiling data for regulatory compliance. Moreover, the database maintaining the data may suffer from inefficient consumption of memory and reduction in usefulness from high errors, missing data, and duplicate entries. Furthermore, from the end-user perspective, end-user devices may experience consumption of computing resources from users repeatedly querying the database and accessing other sources of information to ascertain various pieces of data regarding the delivery and consumption of fuel.

### SUMMARY

Disclosed herein are systems and methods capable of addressing the above-described shortcomings and may also provide any number of additional or alternative benefits and advantages.

To address the technical challenges from logging records on fuel deliveries, a computing network and related online platform serves as a title registry for sustainable aviation fuel (SAF) environmental attributes. The title registry provides, for example, information on the entity having ownership of the environmental attributes associated with each particular unit (e.g., a gallon) of fuel, among other various characteristics of the fuel. In some cases, there may be two claims of ownership to the environmental attributes, and the platform may identify and track one or both entities using a blockchain to provide transparency and traceability of each.

The ownership claims may include direct (sometimes referred to as “Scope 1 emissions”) and indirect (sometimes referred to as “Scope 3 emissions”) claims to the reduction or consumption in the fuel. The platform may provide traceability to both types of ownership claims on a per-unit or a per-metric of carbon dioxide reduction basis. The platform may offer the flexibility between both to satisfy the specifications of both operators and travelers through one platform.

The platform may allow a fuel supplier or producer to register a batch of fuel when produced by generating a token. The batch of fuel may be defined in terms of a total amount of availability and sustainability characteristics. The tokens and by extension attributes may be transferred from one entity to other entities as the fuel is exchanged downstream from the producer. Upon claiming by an end user, the tokens may be retired or marked as to prevent future transfers and enable to show the user of the platform the proof of the claim. This may offer transparency and verifiability to the fuel characteristics purchased, while providing the public traceability for ownership claims.

Embodiments may include systems and method for blockchain based tracking resource production and sustainability. A producer computer of a plurality of computers associated with a blockchain may receive production information indicating an amount of a resource produced, a batch identifier for the resource produced, and a plurality of wallet identifiers for a corresponding plurality of resource recipients. The producer computer may determine a number of blocks for the blockchain to generate for representing a unit of the resource produced of the amount of resource produced. The producer computer may generate a plurality of blocks on the blockchain according to the number of blocks and using the production information. The plurality of blocks may include a plurality of sets of blocks for a corresponding resource recipient of the plurality of resource recipients. Each block in the set of blocks for the corresponding resource recipient including a wallet identifier for the resource recipient.

Embodiments may include systems and methods for blockchain-based tracking resource production and sustainability. A consumer computer associated with a consumer of a plurality of computers associated with a blockchain, may transmit, to a producer computer of the plurality of computers a request for a portion of an amount of a resource. The consumer computer may receive a notification confirming that a blockchain wallet of the consumer has been associated with a set of blocks added to the blockchain, the set of blocks representing the portion of the amount of the resource. The consumer computer may, in response to the consumer computer receiving one or more user inputs for updating a claim status of the portion of the amount of resource represented by the set of blocks, execute a smart contract of the blockchain configured to update the set of blocks to being untradeable.

Embodiments may include systems and methods for blockchain-based tracking resource production and sustainability. A computer of a plurality of computers associated with a blockchain may receive a notification confirming that a first blockchain wallet has been associated with a first set of blocks and a second set of blocks added to the blockchain. The first set of blocks may represent an amount of a resource. The computer may execute a first smart contract of the blockchain configured to transfer the second set of blocks to a second blockchain wallet. The computer may execute a second smart contract of the blockchain configured to update the first set of blocks to being untradeable in response to receiving an update to a claim status for the resource represented by the first set of blocks.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1A illustrates a block diagram of an example system or environment for blockchain-based tracking of resource production and sustainability in accordance with an illustrative embodiment;

FIGS. 1B-1E illustrate examples of graphical user interfaces containing various types of reports, in accordance with the illustrative embodiment;

FIG. 2A illustrates a block diagram of a system for generating blocks for tracking of resource production and sustainability in accordance with an illustrative embodiment;

FIG. 2B illustrates a block diagram of sets of blocks for a blockchain in the blockchain-based tracking of resource production and sustainability in accordance with an illustrative embodiment;

FIG. 2C illustrates a block diagram of correspondences between the sets of blocks for a blockchain in the blockchain-based tracking of resource production and sustainability in accordance with an illustrative embodiment;

FIG. 3A illustrates a block diagram of a system for updating blocks for tracking of resource production and sustainability in accordance with an illustrative embodiment;

FIG. 3B illustrates a block diagram of sets of blocks upon updating for a blockchain in the blockchain-based tracking of resource production and sustainability in accordance with an illustrative embodiment;

FIG. 4 illustrates a block diagram of a system for accessing blocks for tracking resource production and sustainability in accordance with an illustrative embodiment;

FIG. 5 illustrates a flow diagram of an example process of generating blocks for a blockchain in accordance with an illustrative embodiment;

FIG. 6 illustrates a flow diagram of an example process of transferring ownership of blocks in a blockchain in accordance with an illustrative embodiment;

FIG. 7 illustrates a flow diagram of an example process of claiming tokens in a blockchain in accordance with an illustrative embodiment;

FIG. 8 illustrates a flow diagram of an example process of accessing tokens of a blockchain in accordance with an illustrative embodiment;

FIG. 9 illustrates a flow diagram of an example process of querying tokens of a blockchain in accordance with an illustrative embodiment;

FIG. 10 illustrates a flow diagram of an example method of generating blocks for blockchain-based tracking of resource production and sustainability in accordance with an illustrative embodiment;

FIG. 11 illustrates a flow diagram of an example method of claiming blocks for blockchain-based tracking of resource production and sustainability in accordance with an illustrative embodiment; and

FIG. 12 illustrates a flow diagram of an example method of updating blocks for blockchain-based tracking of resource production and sustainability in accordance with an illustrative embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

The present disclosure is directed to systems and methods of blockchain-based tracking of resource consumption and environmental attributes. To address the technical challenges arising from the logging of records on fuel deliveries, a platform may be provided to facilitate the management of a title registry for resources and related environmental or sustainability attributes (e.g., sustainable aviation fuel (SAF) and environmental impacts). The title registry may be established, maintained, and updated using a blockchain on a distributed network environment. The blockchain may include a set of tokens (or blocks) referencing units of resources produced, distributed, and consumed by different entities. Using their blockchain wallets, association of tokens in the blockchain may be updated from one entity to another entity.

In some embodiments, the systems and methods described herein implement the blockchain functions and features as a cross-supply chain inventory management tool, allowing various actors in the fuel supply chain to consistently and confidently track fuel inventories and transactions. Additionally or alternatively, in some embodiments, the systems and methods described herein implement the blockchain functions and features digital registry for tracking ownership of sustainability attributes attached to certain batches or units of SAF fuel in the form of sustainability attribute credits, which may be carbon offset credits or the like. A sustainability attribute credit can be registered to the blockchain by a producer (or another user in the system who owns the fuel being registered). The sustainability attribute (indicating the sustainability attribute credit) can follow the fuel through physical delivery or be decoupled from the physical fuel and sold independently.

To create a record when a batch of a resource is to be delivered by a producer entity, a computing device associated with the producer entity may collect or receive information regarding the batch of resource via a user interface. The information regarding the resource may identify, for example, a type of resource, a location, a size, volume, and density of the resource, production pathway, and blending, among other characteristics. The information may also include a certificate for environmental impact, and an identification of scheme for the certificate (e.g., Carbon Offsetting and Reduction Scheme for International Aviation (CORSIA)), among others. The computing device may also collect information regarding recipients of the resource via the user interface, such as wallet identifiers for the corresponding recipients of the delivered resource.

Upon the receipt of the information, the computing device of the producer entity may determine a number of tokens (or blocks) to generate for addition to the blockchain. The number of tokens may be determined as a function of the total batch size for the resource, among other factors. For example, for a batch of 30,000 gallons of aviation fuel, the computing device may calculate that 30,000 tokens would be generated for the batch. With the determination, the computing device may generate sets of tokens corresponding to the batch of resources. As the tokens are generated, the computing device may add each token to the blockchain in the network.

Each set of tokens may total the determined number of tokens to be generated. Each token may represent a unit of the batch (e.g., 1 batch of 30,000 gallons of aviation fuel) initially associated (or owned) by the producer entity and to be delivered to the recipient as identified with the wallet identifier. Each token may also be unique (e.g., in the form of a non-fungible token (NFT)) containing data written based on the information inputted via the user interface and a unique identifier for the sub-unit. Each token may also include a smart contract for updating a state of the token corresponding the claiming of the unit of the resource.

Furthermore, each set may represent a different type of environmental impact for the resources. For example, one set of tokens may correspond to a direct environmental impact (e.g., Scope 1 emissions) from a source associated with the producer entity. Another set of tokens may correspond to an indirect environmental impact (e.g., Scope 3 emissions) caused by another entity from expending the unit of resource. The tokens across each set may correspond to the same unit of resource in the batch.

To lay claim to units of the resource supplied by the producer entity, a computing device associated with a recipient entity (e.g., an airline, a fuel distributor, or passenger) may send a request for the units of the resource to the producer entity. In generating and sending the request, the computing device may receive information for the request, such as the size, volume, and density of the resource to be used by the recipient entity. The information may also include the wallet identifier for the recipient entity and a type of the recipient entity. Based on the requested batch size, the computing device may also determine the number of corresponding tokens to include in the request. In some circumstances, a recipient requests a transfer of the fuel emission claims. Additionally or alternatively, in some circumstances, it will be a current owner of the resources initiating a transfer.

In addition, the computing device may select which set of tokens to claim using the type of recipient entity. For example, when the type of recipient entity is identified as an airline operator, the computing device may identify the set of tokens corresponding to direct environmental impact. On the other hand, when the type of recipient entity is identified as a distributor or passenger, the computing device may identify the set of tokens corresponding to indirect environmental impact. The request may include the identification of the set of tokens corresponding direct or indirect impact.

Upon receipt of the request, the computing device of the producer entity may update an association of a subset of tokens from the producer entity to the recipient entity. The tokens in one set (e.g., direct environmental impact) may be updated, without affect the corresponding tokens in the other set (e.g., indirect environmental impact). In updating, the computing device may select the set of tokens corresponding to the type of recipient entity and by extension to the direct or indirect environment impact as identified in the request. With the selection, the computing device may identify a subset of tokens totaling the requested number of tokens. For each identified token, the computing device may update association from the producer entity to the recipient entity. In updating, the computing device may transfer the ownership of the subset of tokens to the recipient entity using the wallet identifier. The computing device of the producer entity may also send a response notifying the computing device of the recipient entity of the update.

With the response, the computing device of the recipient entity may identify that the association the requested subset of tokens has been updated to the recipient entity. Upon request, the computing device may also execute the smart contract in each token whose ownership is transferred from the producer entity to the recipient entity. For instance, when the corresponding units of the resource are used or consumed, a user of the consumer entity may input a request for claiming the units via a user interface presented on the computing device. From executing the smart contract, the claim status of the corresponding token may be updated to untradeable. The computing device may also transfer from the set of tokens from the initial wallet to a burn wallet to remove the tokens from circulation in the blockchain in the distributed network.

To retrieve various data regarding the resources, a computing device of any entity (e.g., independent of the producer or consumer entities) may query the blockchain. The computing device may use identifiers of tokens to fetch information regarding the corresponding units of resource from the associated tokens, such as association, claim status, and other attributes. The computing device may also be provided a report for the tokens in the blockchain platform. The report may identify entities associated with production and transfer of resources, number of transferred, owned, transferred, and burned tokens for each entity, historical report of tokens transferred from one entity to another, and current inventory of available tokens, among others.

In this manner, the blockchain of the distributed network environment may provide for a systematized record of the production, delivery, consumption, and claiming of resources, with a unique token representing each unit of resource. The blockchain may also allow for proof of ownership or association for each unit of fuel transferred among the various entities. By having this systemized record with proof of ownership in the blockchain, the records for the transferal and use of the resources may be more accurate, relative to manual records or other forms of database cataloguing. The record may also be less prone to duplication or redundancies, as each token is unique and represents a corresponding unit of resource. The blockchain may thus improve data integrity and accessibility to various entities, and reduce inefficient consumption of computing resources from processing inaccuracies and redundancies as in other forms of cataloguing.

Several embodiments and examples described herein reference aircraft and jet fuel, but embodiments are not so limited. The types of fuel and vehicles may include, for example, an automobile (e.g., sedan car, van, bus, truck), railed vehicles (e.g., trains, trams), watercraft (e.g., ship, boat, hovercraft, submarine), aircraft (e.g., airplane, helicopter, drone), and spacecraft (e.g., launch vehicle, carrier rocket), among others.

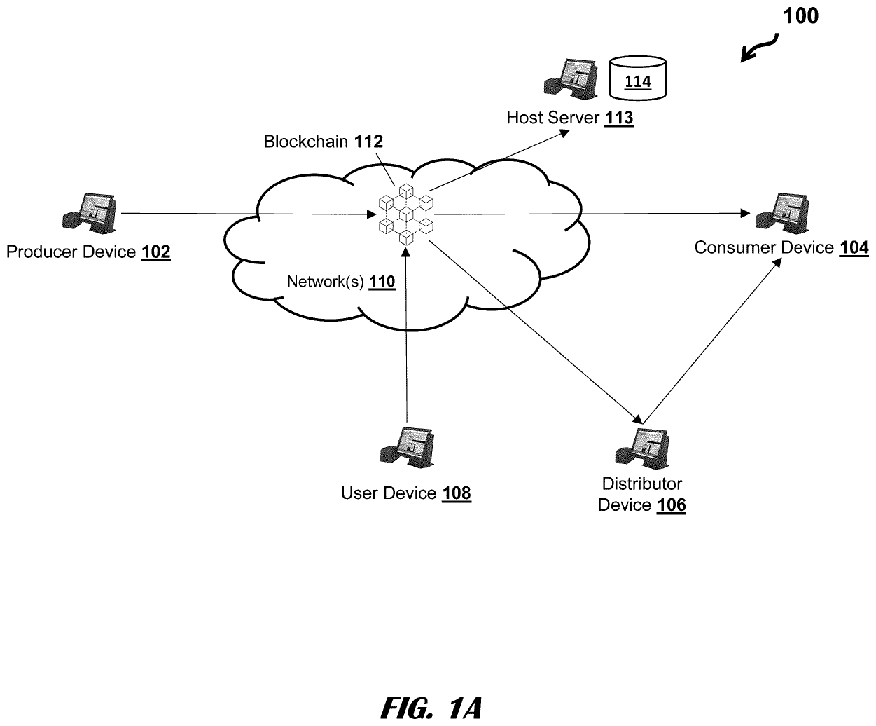

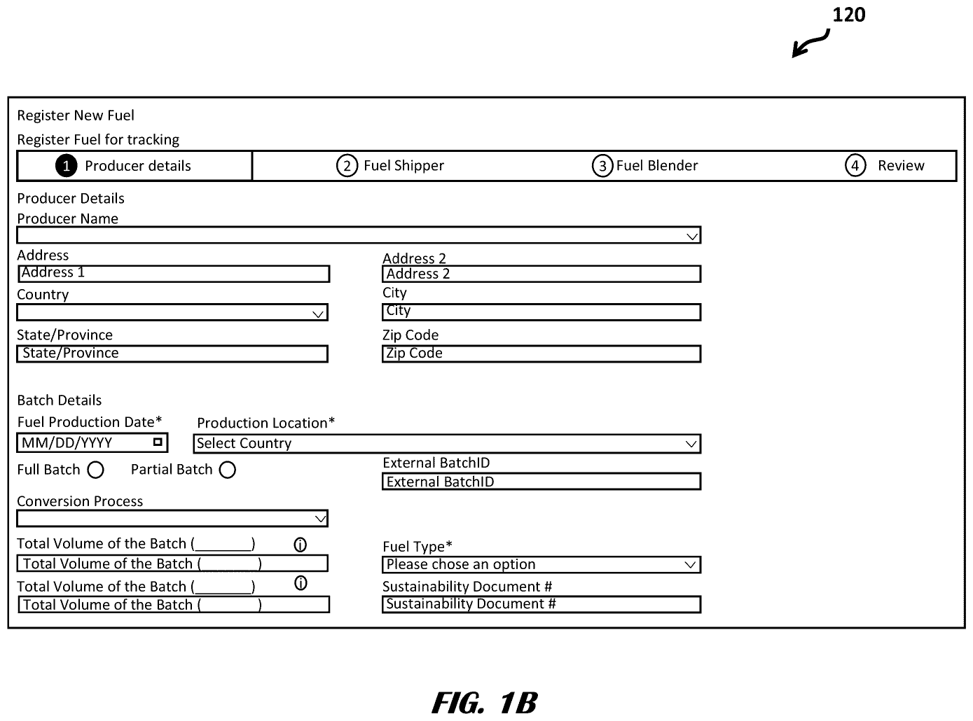

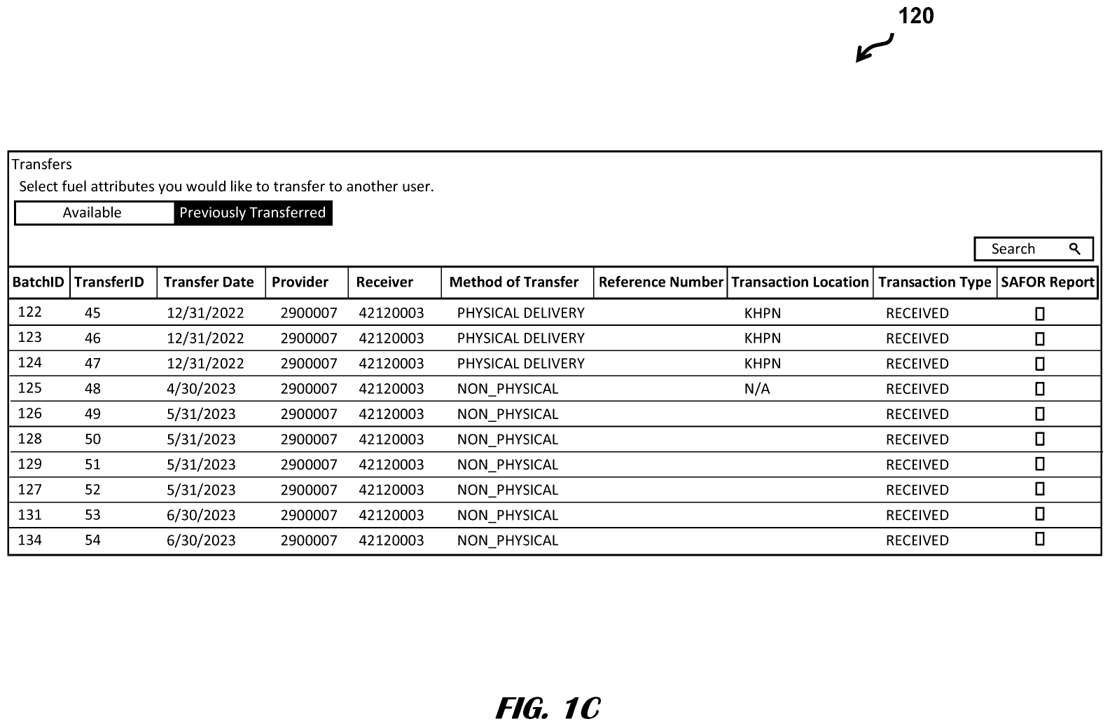

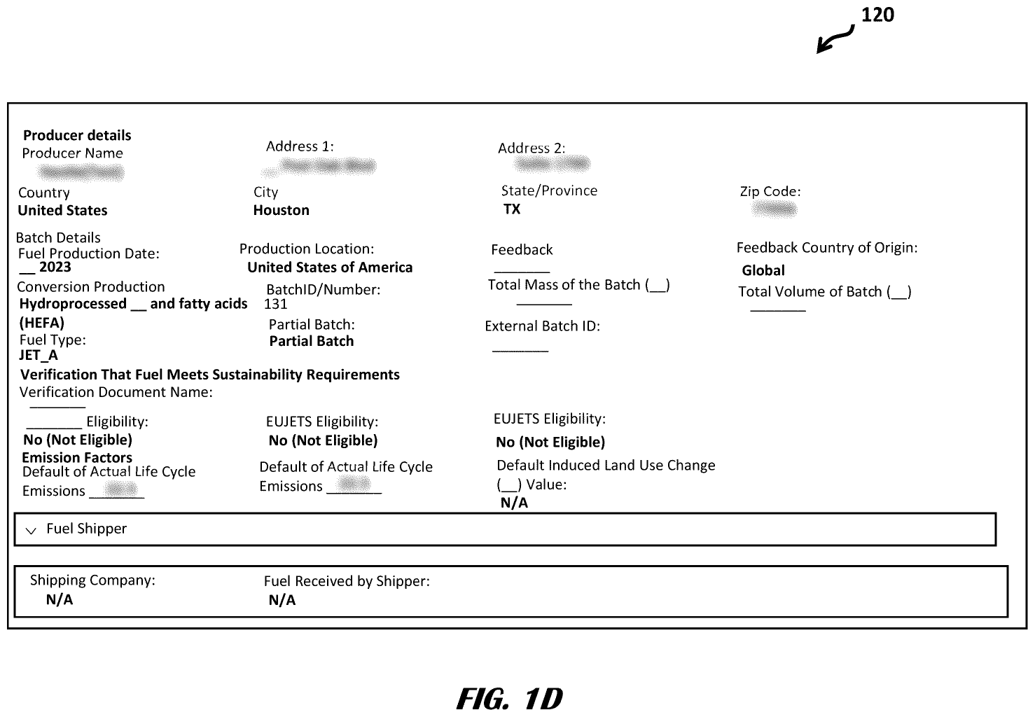

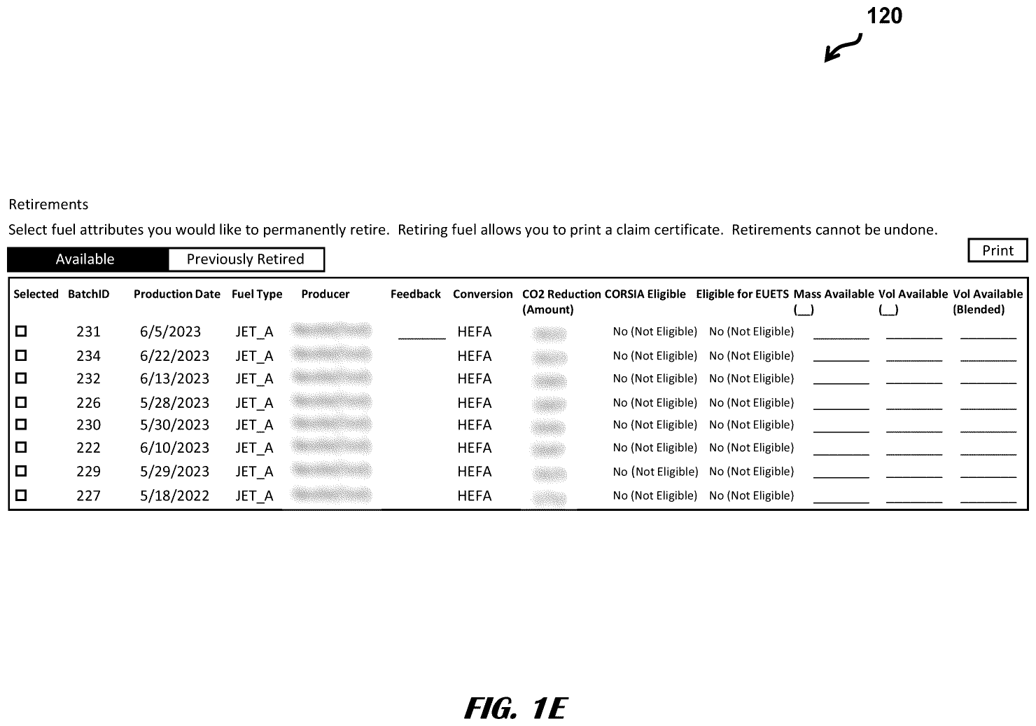

FIG. 1A illustrates a block diagram of an example environment or system 100 for blockchain-based tracking of resource production and sustainability. FIGS. 1B-1E illustrate examples of a graphical user interface 120 containing various types of information related to end-users, producers, and consumers participating in the system 100. As depicted, the environment 100 may include at least one producer device 102, at least one consumer device 104, at least one distributor device 106, a host server 113, a host database 114, and at least one independent user device 108, among others, communicatively coupled with one another via one or more networks 110. The network 110 may include at least one blockchain 112 maintained on one or more nodes of the system 100. The system 100 as illustrated in FIG. 1A is described as having one of each component for ease of description and understanding of an example. It should, however, be appreciated that embodiments may include any number of the components described herein. It should be further appreciated that embodiments may comprise additional or alternative components, or may omit certain components, and still fall within the scope of this disclosure.

The producer device 102 may be any computing device comprising one or more processors coupled with memory and software, and capable of performing the various processes and tasks described herein. The producer device 102 may be in communication with the consumer device 104, the distributor device 106, and the user device 108 via the one or more networks 110. The producer device 112 may be associated with a fuel producer entity to harvest, produce, or supply resources for vehicles. The resources may include, for example, petroleum-based fuels (e.g., gasoline, diesel, liquefied petroleum, ethanol, and biodiesel), kerosene-based fuels (e.g., Jet A, Jet A-1, JP-5, and JP-8), natural gas (e.g., compressed natural gas and liquefied natural gas), hydrogen fuels, synthetic fuel, or electricity, or any combination thereof (e.g., jet fuel as a combination of various hydrocarbon-based fuels), among others. The producer device 102 may be used by an operator of the fuel producer entity to upload information regarding a batch of resources to register and record on the blockchain 112 as a set of tokens.

The consumer device 104 may be any computing device comprising one or more processors coupled with memory and software, and capable of performing the various processes and tasks described herein. The consumer device 104 may be in communication with the producer device 102, the distributor device 106, and the user device 108 via the one or more networks 110. The consumer device 104 may be associated with a fuel end-consumer entity to receive, use, or consume the resources on vehicles of the entity. The vehicles may include, for example, an automobile (e.g., sedan car, van, bus, truck), railed vehicles (e.g., trains, trams), watercraft (e.g., ship, boat, hovercraft, submarine), aircraft (e.g., airplane, helicopter, drone), and spacecraft (e.g., launch vehicle, carrier rocket), among others. In general, the consumer entity may be responsible or otherwise associated with the expenditure of the resources provided by the fuel producer entity. The consumer device 104 may be used by an operator of the fuel consumer entity to update or transfer ownership or association of tokens as maintained on the blockchain 112 from one entity to itself, to record the consumption of corresponding amount of resources.

The distributor device 106 may be any computing device comprising one or more processors coupled with memory and software, and capable of performing the various processes and tasks described herein. The distributor device 106 may be in communication with the producer device 102, the consumer device 104, and the user device 108 via the one or more networks 110. The distributor device 106 may be associated with a fuel distribution entity to receive, transport, and provide to the end-consumer fuel entity. For example, the distribution entity may be an entity for transporting fuel from the fuel producer to the vehicle or an entity for temporarily storing the fuel at a given location (e.g., a fuel silo at a gasoline station or an airport). The distributor device 106 may be used by an operator of the fuel distribution entity to update or transfer ownership or association of tokens as maintained on the blockchain 112 from one entity to itself, to record the carrying or distribution of corresponding amount of resources. In some circumstances, a distributor may need to retire on behalf of an end operator. Additionally or alternatively, in some circumstances, a fuel producer may do the same.

The user device 108 may be any computing device comprising one or more processors coupled with memory and software, and capable of performing the various processes and tasks described herein. The user device 108 may be in communication with the producer device 102, the consumer device 104, and the distributor device 106 via the one or more networks 110. The user device 108 may be associated with any entity aside from or in addition to the previously referenced fuel producer entity, the fuel consumer entity, or the distributor entity. The user device 108 may be used to access the blockchain 112 to view various information about the production, delivery, and consumption of resources among the other entities on the platform.

The one or more networks 110 may include any number of public networks and/or private networks, which could include computing networks or telecommunications networks. The network 110 comprises hardware and software components implementing various network and/or telecommunications protocols facilitating communications between various devices, which may include the devices of the system 100 or any number of additional or alternative devices not shown in FIG. 1A. For example, the network 110 includes a cellular network, a Wi-Fi network (or other wired local area network (LAN) or wireless LAN), a WiMAX network or other wireless or wired wide area network (WAN), and the like.

The computing devices of the system 100 including the producer device 102, the consumer device 104, the distributor device 106, and the independent user device 108, among others, may execute processes to initiate, establish, maintain, update, or access the blockchain 112 on the network 110. In some embodiments, any form of distributed ledger, such as a ledger table, may be used as the blockchain 112. The blockchain 112 may include one or more blocks (sometimes herein referred to as nodes, entries, or tokens) to record various types of data regarding the units of resources themselves and associated attributes. The ownership or association of the tokens to one of the entities (e.g., the producer, consumer, and distributor entities) may be kept track using a blockchain wallet identifier for the corresponding entity. The blocks of the blockchain 112 may be maintained across nodes of the network, such as the computing devices of the system 110 and databases accessible by the computing devices, among others. The processes performed or executed by the one or more computing devices of the system 110 in relation to the blockchain 112 may include those detailed herein below.

In some embodiments, the system 100 includes a host server 113 associated with the fuel-tracking service that administers or manages the various features and functions described herein. The host server 113 may include any computing device comprising hardware and software components capable of performing the various processes described herein. For instance, the host server 113 executes software programming (e.g., webserver, web-application) hosting or analyzing fuel-related data stored in a non-transitory machine-readable storage hosting a database 114. The server 113 may query the database 114 generate various types of reports that may be presented via one or more graphical user interfaces 120. In some implementations, the host server 113 receives the uploaded documents via the one or more networks 110 and stores such documents or fuel information derived from the documents into non-transitory, machine-readable storage containing a database 114 that stores, for example, user information and fuel information.

FIGS. 1B-1E illustrates an example user interface 120 for registering new fuel in the system 100, which may include minting a new block on the blockchain 112. The end-user operates the user device (e.g., producer device, consumer device) to access the graphical user interface 120 of a web-based or locally installed application. The graphical user interface 120 includes a dashboard for managing and reviewing information related to the fuel that has been or will be tokenized onto the blockchain 112, representing the particular user's inventory and/or consumption.

FIG. 1B illustrates the graphical user interface 120 presenting a user with options for registering and tokenizing one or more new batches of fuel on the blockchain 120. The graphical user interface 120 presents an interactive form that accepts user inputs into various fields, allowing the system 100 and blockchain 112 to collect and tokenize information about the fuel, including, for example, sustainability data, blending data, production sustainability certifications, carbon intensities, lifecycle factors, and other data for tracking and evaluating fuel.

In some embodiments, the user registering the fuel uploads machine-readable files (e.g., word processing document files) containing fuel information to a host server 113 via the one or more networks 110. The host server 113 is associated with the fuel-tracking service, which administers or manages the various features and functions described herein. The host server 113 may include any computing device comprising hardware and software components capable of performing the various processes described herein. The host server 113 receives the uploaded documents via the one or more networks 110 and stores such documents or fuel information derived from the documents into non-transitory, machine-readable storage containing a database 114 that stores, for example, user information and fuel information.

After the user enters the fuel information, the host server 113 or one or more of the participating devices of the system 100 may execute processes for tokenizing the fuel information as one or more blocks of the blockchain 112. In some implementations, the server 113 or other devices perform software-automated or manual verifications of the new fuel information before the information is tokenized on the blockchain 112. The server 113 retrieves the fuel information from the database 114 to verify the fuel information entered via this user interface 120 against one or more documents or other fuel information stored in the database 114 of the system 100. The host server 113 or other device may return the fuel information and present the user interface 120 with a prompt indicating success or noting one or more discrepancies in the fuel information entered via the user interface of FIG. 1B. In the event of discrepancies (e.g., the server 113 or verifying user identified a threshold amount of errors), the user interface 120 of the producer device 102 may present the user another opportunity to register the fuel.

FIG. 1C illustrates an example graphical user interface 120 displaying transfer information at a computer device of the system 100, such as a distributor device 106. After the fuel producer completes the registration process, the producer typically transfers ownership of the fuel to a fuel distributor at any quantity. A user at the fuel distributor may operate the distributor device 106 to access the distributor's fuel information, which may include accessing the graphical user interface 120 for displaying transfers, allowing the distributor to review the amounts or types of fuel transferred to the distributor from one or more producers, and/or review the amounts or types of fuel that the distributor has transferred to other distributors or to consumers. Similarly, other downstream distributors (e.g., wholesale distributors, airports) and consumers (e.g., airlines, passengers, aircraft owners) may receive fuel transferred from upstream distributors (or producers), and access the graphical user interface 120 of FIG. 1C to review, for example, fuel information or other information related to fuel transfers.

As an example, a fuel distributor receives 100,000 gallons from a fuel producer. The distributor parses the 100,000 gallons into multiple truckloads, where each truck contains 8,000 gallons, and the trucks are used to distribute the fuel to various airport customers. The fuel information and ownership transactions may be reflected in one or more blocks of the blockchain 112. The producer device 102 may access the blockchain 112 or the host device 114, and display the graphical user interface 120 containing the transfer information and the fuel information as stored on the blockchain 112 reflecting the transfers to the distributor. Similarly, the distributor device 106 may access the blockchain 112 or the host device 114, and display the graphical user interface 120 containing the transfer information and the fuel information as stored on the blockchain 112 reflecting the transfers from the distributor and the transfers to the airports. The host server 113 or other device may generate these fuel transfer reports or receipts, for display on the graphical user interface 120, to prove that the downstream distributor or customer received the particular fuel delivery or deliveries.

In some cases, the transfer report shows that the fuel is either physically delivered (e.g., to the particular airport), or non-physically transferred via a different chain of custody mechanism (e.g., ownership changed without physical relocation). For example, the graphical user interface 120 and the blockchain 112 may capture and reflect transfer information for a book and claim transaction. A book and claim logically decouples a sustainability attribute of the fuel of the physical fuel from the physical energy of that fuel. The fuel producer located around Los Angeles may want to deliver fuel to an airport near Los Angeles, rather than deliver to an airport customer located in New York. However, an airline customer that rarely goes to Los Angeles may want to claim or burn the fuel as being spent on an aircraft departing from a New York airport. A book and claim is a type of transaction that attempts to reconcile these needs (e.g., the geography of supply versus the geography of demand). The fuel producer agrees to distribute the fuel into the Los Angeles airport and the host server 113 or producer device 102 executes a transfer function that decouples a sustainability attribute from the fuel information stored in the blockchain 112 and the records of the database 113. The transfer function may reattach the sustainability attribute to the fuel information when the fuel is delivered at the downstream distributor or customer. In this way, downstream distributor or airline in New York receives the benefit of claiming sustainable fuel, without taking delivery of physical fuel. The producer sells the fuel at the Los Angeles airport as ordinary fossil fuel (without a sustainability attribute), and the sustainability attribute is essentially sold to the downstream distributor, airport, or airline in New York, resulting in a virtual or logical transfer of the sustainable fuel to the downstream distributor, airport, or airline.

A customer or other end-user may access the transfer reports (or other reports containing fuel information), via the graphical user interface 120, to review, for example, information about the fuel batches of the fuel units when produced (e.g., where fuel was produced, the original entity that produced the fuel, the sustainability attribute of the fuel). In this way, the blockchain 112 and the host database 113 may track and update the sustainability attribute of the fuel until the fuel is claimed, which provides the users of the system 100 access to stored fuel information through the fuel's lifecycle. For instance, the user device 108 of an end-user passenger may request a report that indicates proof that the end-user bought sustainable fuel as a virtual sustainability attribute (e.g., carbon offset or sustainability attribute credit). The report indicates how the downstream customer obtained the fuel and that only the downstream customer has a right to claim the sustainable attribute credit. The sustainability attribute(s) of the fuel information indicates, for example, whether the fuel is eligible for a sustainable attribute credit claim, a type of fuel offset (e.g., directly owned offset credit, virtual credit ownership, scope 1, scope 3), and the owner of the sustainable attribute credit, among other potential types of information indicating the sustainability credit of certain fuel.

In some embodiments, the user devices may upload computer files to the host server 113 and/or to the blockchain 112 containing transfer information between users. In some cases, the host server 113 may apply character recognition operation on the transfer data file to extract the transfer information. The host server 113 may store the transfer information into the host database 114, which may include a location linked to from a pointer of a block of the blockchain 112. The transfer information includes, for example, fuel batch identifier, fuel unit identifier, owner identifier(s), transferor identifier(s), recipient identifier(s), amount of fuel (e.g., volume, mass, gallons, other types of units), fuel-type data (e.g., octane, quality, machinery type), sustainability attribute, blended fuel data, and machinery identifier (e.g., aircraft tail number, automobile tag or VIN, boat name or registration number), fuel token identifier(s), among other types of information about the transfer or the fuel.

FIG. 1D illustrates an example graphical user interface 120 displaying a fuel report containing various types of fuel information about a particular unit of fuel for display to an end-user. The fuel report may be accessed and generated by the host server 113 or other computing device of the system 100. The host server 113 may retrieve and present types of information via the graphical user interface 120. Certain types of fuel information and/or transaction information may be private. As such, the host server 113 may limit the types of information presented on the graphical user interface 120 in accordance with preconfigured access privileges assigned to the fuel owner or to a user's role (e.g., producer, distributor, consumer). As shown in FIG. 1D, the fuel report of the graphical user interface 120 contains sustainability verification information that confirms that, for example, the fuel was automatically or manually verified against the prestored fuel information in the blockchain 112, the database 114, or other data source of the system 100.

FIG. 1E illustrates an example graphical user interface 120 displaying a retirement report containing various types of information about fuel units or batches of fuel units consumed by an end-consumer (e.g., airline, airplane owner, passenger). When the consumer is ready to claim the sustainability attribute credit on the fuel unit, the consumer device 104, host server 113, or other computing device of the system 100 may execute a retirement operation. The retirement operation includes executing a token burn function of an on-chain or off-chain smart contract. The burn function renders the token(s) for the fuel non-transferable to any blockchain wallets.

In some implementations, the consumer may enter various types of additional information about the fuel consumption when performing the retirement function. The graphical user interface 120 may include an interactive component, such as an input field or selectable button, allowing the user-consumer to begin the retirement operation. In some cases, the graphical user interface 120 may include an interactive component indicating the user is consuming or retiring the fuel as a sustainability attribute credit. In some cases, the sustainability attribute offset may be claimed and transferred to a third-party. For instance, an airline may trigger the retirement process and indicate a passenger account information to instruct the server 113 to transfer the credit offset to the passenger's account. A retirement report for the passenger account may then display data for fuel retirements and/or sustainability attribute credits (e.g., carbon offsets), claimed or transferred to the passenger.

In some cases, the host server 113 generates a retirement receipt or certificate that indicates the consumer(s) associated with the retirement, such as an airline and passenger. In this way, the user may retrieve and produce a computer file or graphical user interface 120 containing a claim receipt containing the retirement information for each retired unit of fuel. For instance, the retirement report indicates the retired units of fuel of a particular user. A user may interact with a particular entry presented on the retirement report to access a receipt. The server 113 may generate a computer file (e.g., PDF) containing the receipt that includes the data of the fuel that was claimed by the particular during the retirement process.

In some cases, the retirement and/or sustainability attribute claim may be logically “shared” by multiple entities or people, such as instances when the airline transfers or shares the retirement claims with the passenger. In this way, the host server 113 may generate the receipts representing the optional “scope 1” and “scope 3” differences. Likewise, these receipts may represent fractional ownership over of the aircraft or the fuel. The receipts may be applied to the blockchain 112, by adding a new block containing the receipt file or by updating a pointer of a token to a storage location containing the receipts.

In some implementations, the host server 113 or consumer device 104 may generate or download a retirement claim receipt from the database 114 in the retirement report of the graphical user interface 120. The retirement receipt may indicate a sustainability attribute associated with the fuel unit that was retired. The consumer device 104 may download one or more retirement receipts as computer files that the consumer may transmit to third-parties. As an example, a passenger-user who frequently travels on private jets may transmit or otherwise publicize the retirement receipts to third-parties (e.g., news outlets) to prove the passenger's carbon footprint is relatively low as reflected in the sustainability attribute and/or the fuel information contained in the retirement receipt(s) of the passenger's account. Additionally or alternatively, the host server 113 may host a publicly webpage containing retirement receipts for users, according to preconfigured permissions indicating the retirement receipts as being publicly available or available to certain end-users (e.g., accountants, regulators) having limited permissions.

In some embodiments, the host server 113 may perform various analytics on the fuel information stored in the database 114 and/or on the blockchain 112. Oftentimes, a fuel producer sells fuel to a distributor, and then the producer no longer has insight into where the fuel is consumed or stockpiled. For compliance purposes, producers or distributors report certain information to governments, but it may be difficult to report the necessary information because the producers or distributors lack the insight need to understand where that fuel was ultimately delivered. The host server 113 may generate various analytics reports containing analytics information for the particular user roles. For instance, the host server 113 executes data analytics for a producer device 102 that can show a producer where the fuel is distributed to and consumed. As another example, banks and insurers may have green, sustainable financing requirements for aircraft ownership or other programs, so the retirement receipts may be referenced by various parties as a source of truth for enforcing sustainability requirements.

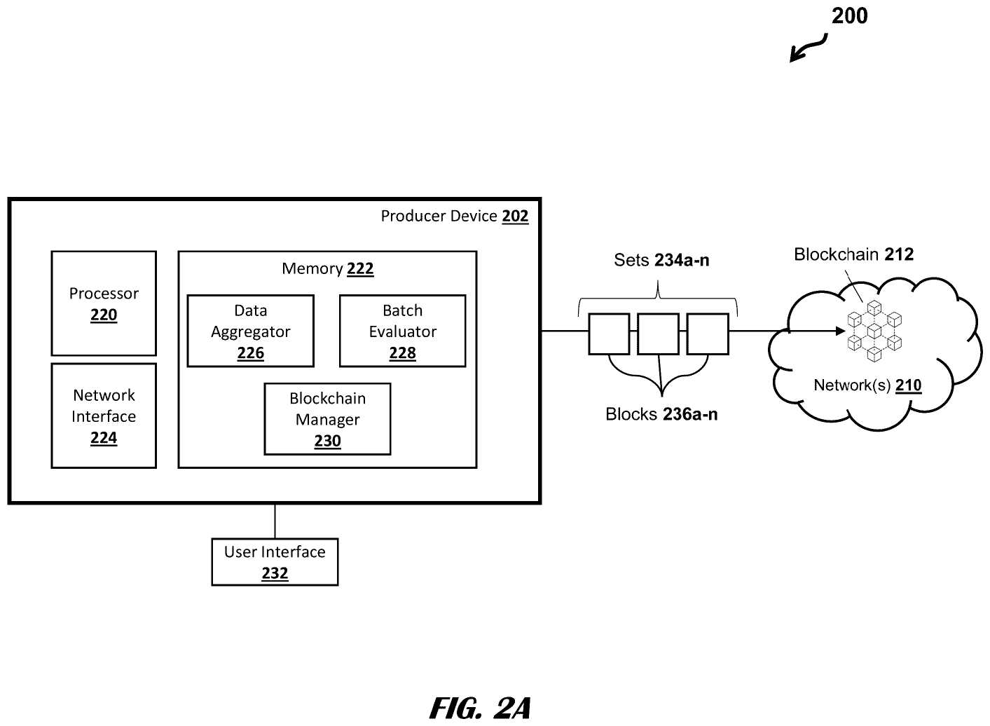

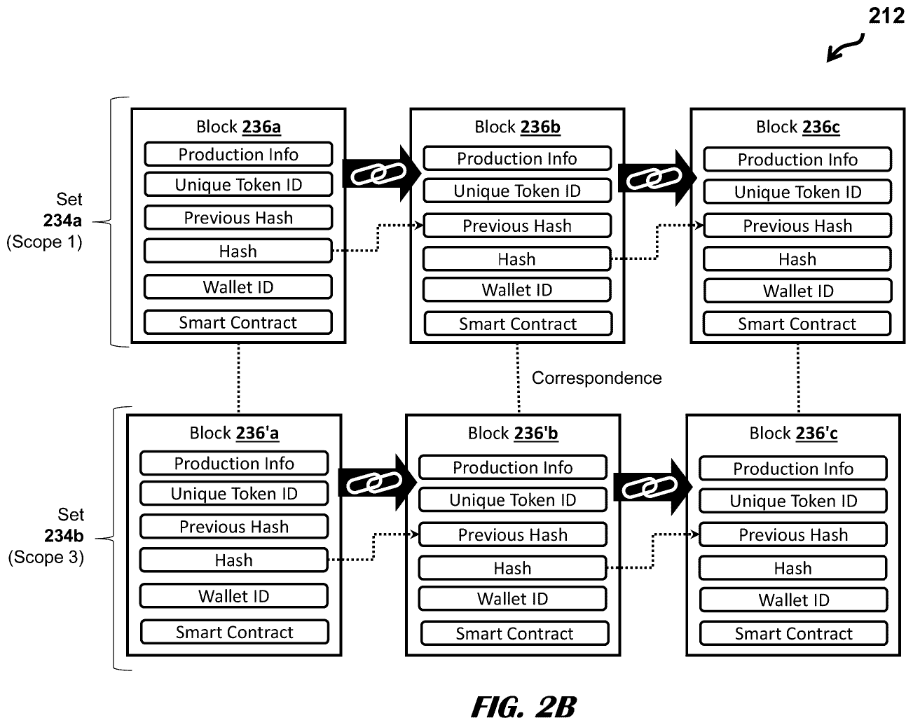

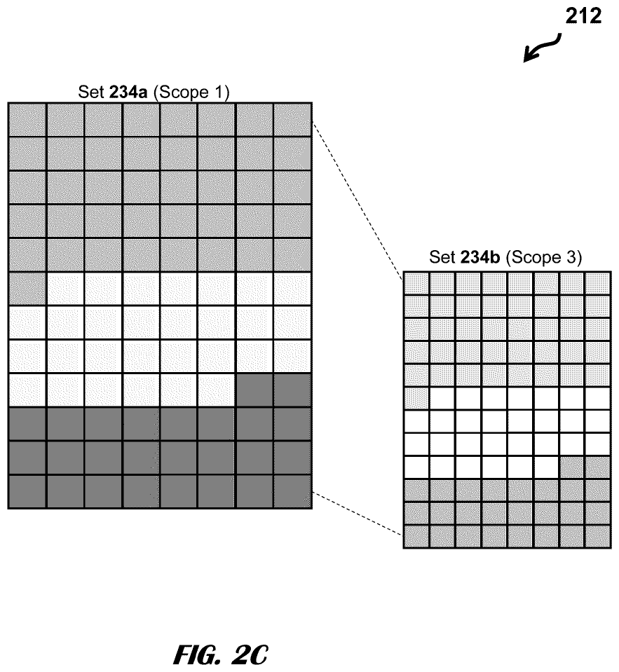

FIG. 2 illustrates a block diagram of a system 200 for generating blocks for tracking of resource production and sustainability. In overview, the system 200 may include at least one producer device 202 and one or more networks 210. The producer 202 device may include processor 220, memory 222, and at least one network interface 224. The memory 222 may store, maintain, or otherwise include instructions to run at least one data aggregator 226, at least one batch evaluator 228, and at least one blockchain manager 230, among others. The processor 220 may perform or carry out operations performed by the producer device 202, such as those stored on the memory 222. The network interface 224 may include one or more components, such as a transmitter, receiver, or network interface card (NIC), to communicatively couple the producer device 202 with the network 210.

Embodiments may comprise additional or alternative components or omit certain components from those of FIG. 2A and still fall within the scope of this disclosure. Various hardware and software components of one or more public or private networks may interconnect the various components of the system 200. Each component in system 200 may be any computing device comprising one or more processors coupled with memory and software and capable of performing the various processes and tasks described herein.

The data aggregator 226 executing on the producer device 202 may display, present, or otherwise provide at least one user interface 232 to retrieve, collect, or receive production information. The production information may be for a batch of resources to be provided by the producer entity and registered on the blockchain 212. The user interface 232 may be a graphical user interface (GUI) rendered on a display of the producer device 202. The GUI may include one or more user interface elements to enter values of various attributes of the batch of resources for the production information. The user interface elements of the GUI may include, for example, text boxes, radio buttons, check boxes, and sliders, among others for indicating the values of the corresponding attributes. The user interface 232 may retrieve, obtain, or otherwise receive one or more user inputs identifying the information. The user inputs for the user interface 232 may be received through use of a gesture recognition system, a keyboard, a stylus, a mouse, or any other input/output (I/O) device of the producer device 202. The registration functions and user interface 232 features related to registering fuel are described in terms of a fuel producer, but embodiments are not so limited. In some cases, other types of users (e.g., distributor, consumer) may register the fuel for the blockchain 212.

Using the one or more inputs, the data aggregator 226 may create, write, or otherwise generate the production information. In some embodiments, the data aggregator 226 may retrieve, identify, or receive the production information from the inputs entered via the user interface 232. The production information may include one or more identifiers associated with the batch of resources and entities in association with the resources. The production information may include a batch identifier for the resources produced. The batch identifier may be, for example, a set of alphanumeric characters to reference the batch of resources to be registered. In some embodiments, the production information may also include an identifier of each recipient entity to receive the batch of resources. The identifier may be, for example, a wallet identifier of the recipient entity to indicate ownership or association of tokens on the blockchain 212. In some embodiments, the production information may lack any identifier for the recipient, at the time of registration of the batch of resources. The production information may also include an identifier for the producer entity associated with the producer device 202 that initiated the registration of the batch of resources.

The production information may identify or include attributes to describe or define the batch of resources to be provided by the producer entity. The attributes of the resources may, for example, identify or include: a feedstock type identifying materials for the resource (e.g., petroleum-based, kerosene-based, hydrocarbon, or synthetic); a feedstock location identifying a geographic location (e.g., in terms of coordinates or address) for the source of the resource; a feedstock production pathway identifying one or more processes used to manufacture or produce the resource; a blend percentage identifying proportions of each material used in the resource; an amount of resources (also referred herein as batch size or mass) (e.g., as measured in grams, kilograms, or tons) for the resource; and a density of resources (also referred herein as a batch density) (e.g., as measured in grams per cubic centimeter, kilograms per cubic meter, or tons per square feet) for the resource, among others.

Continuing on, the production information may identify or include environmental impact attributes. The environmental impact attributes may, for example, include: an estimated emission intensity (sometimes referred herein as carbon intensity) defining an emission rate for the batch of resources relative to an intensity (e.g., as measured in kilograms of the resource per-megajoule of produced energy or kilowatt-hour). The emission may be for carbon monoxide (CO), carbon dioxide (CO₂), sulfur dioxide (SO₂), nitric oxide (NO), nitrogen dioxide (NO₂), or other particulates, among others. In addition, the production information may identify or include: a certificate to verify the indicated environmental impact attributes; a certificate to indicate emission offset or reduction according to a define scheme (e.g., CORSIA), among others. In some embodiments, the production information may include an identifier (e.g., Uniform Resource Locator (URL)) referencing a storage location of the certificates.

The batch evaluator 228 executing on the producer device 202 may calculate, identify, or otherwise determine a number of blocks to be generated for the batch of resources. The determination of the number of blocks may be based on the production information. Each block may represent a unit of the resources produced. The unit may correspond to a portion of the amount of resources equal across the blocks. In some embodiments, the batch evaluator 228 may calculate the number of blocks as a function of the amount of resources produced. For example, under the formula, each block may represent or correspond to a fixed amount (e.g., 1 gallon) of the resources. For a batch of 30,000 gallons, the batch evaluator 228 may determine that 30,000 blocks are to be generated for the batch. In some embodiments, the batch evaluator 228 may determine the number of blocks as a function of the amount of resources, the density, and the environmental impact attribute. For instance, under the formula, each block may represent to a fixed amount of resources, weighed by the estimated emission intensity.

The blockchain manager 230 executing on the producer device 202 may mint, issue, or otherwise generate at least one set 234 of blocks 236a-n (hereinafter generally referred to as blocks 236) using the production information in accordance with the number of blocks. Each block 236 may represent a unit of resources in the batch. For example, each block 236 may represent a one-gallon amount of resource from a batch of resources with the mass of 4,000 gallons. The blocks 236 may contain various types of information relevant to the maintenance of the blockchain 212. The blockchain manager 230 may generate the set 234 of blocks 236 in accordance with a blockchain protocol, such as ERC-1155 standard, Ethereum, Corda, and EOS, among others. For example, a first block 236a may include a unique hash, and a second block 236b may include a previous hash value corresponding on the hash of the first block 236a, and so forth. The second block 236b may also include a unique hash, based at least in part on the previous hash value from the first block 236a. The blockchain manager 230 may repeat the calculation of the hashes in this manner across the set 234 of blocks 236, and between multiple sets 234 representing other batches of resources to be registered on the blockchain 212.

In some embodiments, the blockchain manager 230 may generate blocks 236 to be unique from one another. The generation of the blocks 236 may be in accordance with a non-fungible token (NFT) generation protocol (e.g., ERC-721 standard). The blocks 236 may uniquely identifying data, and may entail additional computationally expensive algorithmic operations to generate. In some embodiments, the blockchain manager 230 may generate a unique token identifier for each block 236. The unique token identifier may be generated as a function (e.g., a hash function) of the production information, including the batch identifier, attributes of the resources, environmental impact attributes, and certificates, or any combination thereof, among others. As NFTs, the blocks 236 may contain or include unique or limited data (e.g., data and a unique token identifier) to represent a particular unit of resource. Due to the inclusion of unique data, the blocks 236 may be non-fungible, not-freely interchangeable with other blocks of the blockchain 212.

In generating, the blockchain manager 230 may insert, add, or otherwise include data from the production information in each block 236. Each block 236 may identify or include at least a portion of the production information for the unit. For example, each block 236 may include the batch identifier, attributes of the resources (e.g., feedstock type, feedstock location, production pathway, blend percentage, and density), emission intensity, and the certificates, among others. In some embodiments, the blockchain manager 230 may include one or more pointers for referencing a storage location of at least a portion of the production information into each block 236. For instance, each block 236 may include a pointer referencing a storage location (e.g., on a database) maintaining the certificate of the emission intensity and another pointer referencing a storage location maintaining the certificate to indicate emission offset or reduction according to a define scheme.

In addition, the blockchain manager 230 may include a wallet identifier corresponding to the owner or entity associated with the block 236. The wallet identifier may be, for example, a set of alphanumeric characters uniquely referencing at least one blockchain wallet for the entity. An entity may be associated with one or more blockchain wallets. When the production information includes the identifier for the recipient entity, the blockchain manager 230 may include the wallet identifier for the recipient entity into a subset of blocks 236 representing the amount of resources to be delivered to the recipient entity. On the other hand, when the production information lacks any identifier for the recipient entity, the blockchain manager 230 may include the wallet identifier for the producer entity into each block 236.

Furthermore, the blockchain manager 230 may insert, add, or otherwise include a smart contract to each block 236. In some embodiments, the smart contract may be a part of the blockchain 212, generally applicable to the blocks 236 thereon. The smart contract may correspond to or may be a script to be executed by the entity with ownership or association of the block 236. In some embodiments, the smart contract included in each block 236 may govern the transfer ownership or association of the block 236. The script included in the smart contract may be executed by the entity with ownership over the respective block 236 to set the block 236 to transfer ownership or association from one entity to recipient entity. The transfer of ownership may be effectuated by setting or updating the wallet identifier from one entity to the wall identifier of the recipient entity.

In some embodiments, the blockchain manager 230 may include a smart contract for configuring a claim status (also referred herein as a tradability or transferability attribute) for the corresponding block 236. The claim status may indicate whether the unit of resource represented by the block 236 has been consumed, accounted, or otherwise used. By extension, the claim status may identify or indicate whether the corresponding block 236 is transferrable or tradeable among the entities. Initially, the smart contract may indicate that the unit of resource is not yet consumed and the associated block 236 is transferrable or tradeable. The script included in the smart contrary may be executed by the entity with ownership over the respective block 236 to set the block 236 as non-transferrable or non-tradeable. The change in claim status may indicate by extension that the associated unit of resource has been consumed by the other entity.

FIG. 2B illustrates a block diagram of a blockchain 212 including two sets 234a and 234b of blocks 236 and 236′ in the blockchain-based tracking of resource production and sustainability. FIG. 2C illustrates a block diagram of correspondences in a blockchain 212 between the sets 234a and 234b of blocks 236 and 236′ for a blockchain in the blockchain-based tracking of resource production and sustainability. In some embodiments, the blockchain manager 230 may generate multiple sets 234a-n (hereinafter generally referred as sets 234) of blocks 236 and 236′. Each set 234 may include the same number of blocks 236 as determined using the production information. Each block 236 in one set 234 (e.g., a first set 234a) may have a corresponding block 236′ in another set (e.g., a second set 234b). The pair of blocks 236 and 236′ across the sets 234 may correspond to the same unit of resources. The pair of blocks 236 and 236′ may contain or include the same data or information, such as the production information, wallet identifier, and smart contract, among others. In some embodiments, the pair of blocks 236 and 236′ corresponding to different data or information relevant to the maintenance of the blockchain 211, such as the previous hash, current hash, and unique token identifier, among others. In some embodiments, the sets 234a and 234b may be maintained on the same blockchain using the different relevant data. In some embodiments, the sets 234a and 234b may be maintained on corresponding blockchains.

The sets 234 themselves may represent or correspond to different types of environmental impacts for the same batch of resources. In some embodiments, the first set 234a may correspond to a direct environmental impact (e.g., Scope 1 emissions) from the consumption of the batch of resource. The blocks 236 of the first set 234a may be used to keep track of the direct environmental impact from the consumption of the corresponding unit of resource. Conversely, the second set 234b may correspond to an indirect environmental impact (e.g., Scope 3 emissions) caused by another entity from the expenditure of the resource. The blocks 236′ of the second set 234b may be used to keep track of indirect environmental impact from the expenditure of the corresponding unit of resource.

The environmental impacts as identified by the sets 234a and 234b may correspond to emission of particulates (e.g., carbon monoxide (CO), carbon dioxide (CO₂), sulfur dioxide (SO₂), nitric oxide (NO), and nitrogen dioxide (NO₂)). The environmental impacts may include other environmental effects (e.g., noise pollution, acid rain, contribution to ozone decay, or generation of waste, among others). An environmental impact may be identified as direct, when caused by a source associated with the owning entity. For example, the combustion of jet fuel on an airplane owned by the entity may be considered a direct. An environmental impact may be identified as indirect, when caused by an entity not associated with the owning entity. For instance, emissions in connection with a passenger on the airplane spending the fuel or a carrier of the fuel from one location to the next location may be considered an indirect.

With the generation, the blockchain manager 230 may insert or add each block 236 to the blockchain 212. In some embodiments, the blockchain manager 230 may add blocks 236 of one set 234 to the corresponding blockchain 212. For example, the blockchain manager 230 may add blocks 236 of the first set 234a and blocks 236′ of the second set 234b to the corresponding blockchains 212. In adding the blocks 236, the blockchain manager 230 may broadcast, provide, or otherwise transmit an indication of the addition to the other computing devices of the network 210, such as those associated with the fuel distribution, consumption, and other end user entities. The addition of the blocks 236 may also correspond to the registration of the units of resources to be provided as represented by the blocks 236.

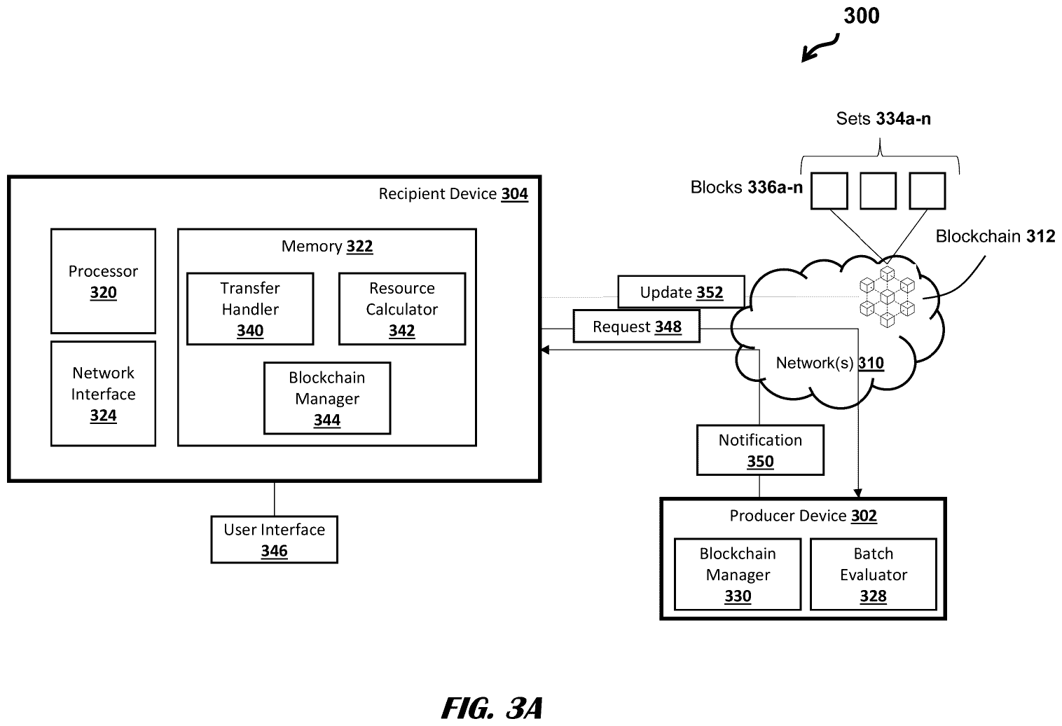

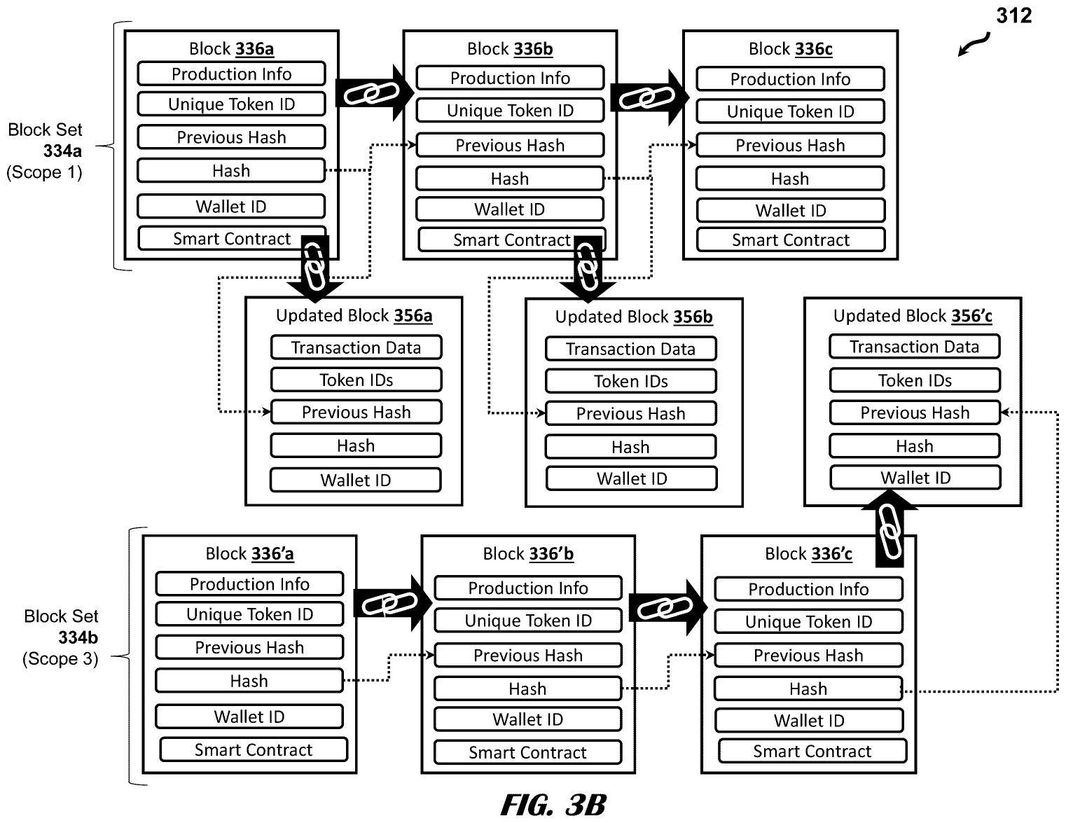

FIG. 3A illustrates a block diagram of a system 300 for updating blocks for tracking of resource production and sustainability. In overview, the system 300 may include at least one producer device 302, at least one recipient device 304 (or at least one distributor device 306), and one or more networks 310. The producer device 302 may include at least one batch evaluator 328 and at least one blockchain manager 330 executing thereon. The recipient device 304 may be associated with a recipient entity, such as a consumer entity or a distributor entity. The recipient device 304 may include processor 320, memory 322, and at least one network interface 324. The memory 322 may store, maintain, or otherwise include instructions to run at least one transfer handler 340, at least one resource calculator 342, and at least one blockchain manager 344, among others. The processor 320 may perform or carry out operations performed by the producer device 302, such as those stored on the memory 322. The network interface 324 may include one or more components, such as a transmitter, receiver, or network interface card (NIC), to communicatively couple the recipient device 304 with the network 310.

Embodiments may comprise additional or alternative components or omit certain components from those of FIG. 3A and still fall within the scope of this disclosure. Various hardware and software components of one or more public or private networks may interconnect the various components of the system 300. Each component in system 300 may be any computing device comprising one or more processors coupled with memory and software and capable of performing the various processes and tasks described herein. While discussed primarily in relation with the recipient device 304, the distributor device 306 may include similar components and carry out the processes detailed herein.

The transfer handler 340 executing on the recipient device 304 may display, present, or otherwise provide at least one user interface 346 to generate at least one request 348 for a portion of an amount of a resource. The user interface 346 may be a graphical user interface (GUI) rendered on a display of the recipient device 304. The GUI may include one or more user interface elements to enter various parameters in relation to the request. The user interface elements of the GUI may include, for example, text boxes, radio buttons, check boxes, and sliders, among others for indicating the values of the corresponding parameters. The user interface 346 may retrieve, obtain, or otherwise receive one or more user inputs identifying the information. The user inputs for the user interface 346 may be received through use of a gesture recognition system, a keyboard, a stylus, a mouse, or any other input/output (I/O) device of the recipient device 304.

Via the interface 346, the transfer handler 340 may retrieve, identify, or receive the one or more inputs. The inputs may include or identify the amount of resources requested to be transferred to the recipient entity (e.g., the consumer or distributor entity). The amount of resources may identify a mass (e.g., as measured in grams, kilograms, or tons) for the resource. The inputs may include an identifier for the producer entity associated with the producer device 302, such as the wallet identifier for the producer device 302. In some embodiments, the inputs may identify or include other attributes for the resource, such as: a feedstock type; a feedstock location; a feedstock production pathway; a blend percentage; a density of resources; certificate-related information; and environmental impact attributes, among others. In some embodiments, the inputs may a type of environmental impact, such as direct impact (e.g., Scope 1 emissions) or indirect impact (e.g., Scope 3 emissions).

Using the one or more inputs, the transfer handler 340 may produce, output, or otherwise generate the request 348. The request 348 may be for a portion of an amount of a resource from the producer entity associated with the producer device 302. The request 348 may identify the amount of resources to be transferred to the recipient entity. In some embodiments, the request 348 may identify or include the other attributes for the resource. In some embodiments, the request 348 may include an identifier for the recipient device 304, such as the wallet identifier for the recipient device 304. In some embodiments, the request 348 may identify or include the type of environmental impact (e.g., direct or indirect impact). In some embodiments, the transfer handler 340 may identify the producer device 302 to which to send the request 348 based on the identifier for the producer device 302 from the input. Upon generation, the transfer handler 340 may provide, send, or otherwise transmit the request 348 to the producer device 302.

In some embodiments, the request 348 may be to update an ownership or association of a number of blocks corresponding to the units of requested resource from one entity to the recipient entity. Each block may correspond to a unit of the requested resources, and the total number of blocks may correspond to the total amount of the requested resources. The unit may correspond to a portion of the amount of resources equal across the blocks. To determine the number of blocks, the transfer handler 340 may invoke the resource calculator 342.

The resource calculator 342 executing on the recipient device 304 may calculate or determine the number of blocks based on the input parameters for the request. The determination of the number of blocks may be in response to the invocation. In some embodiments, the resource calculator 342 may calculate the number of blocks as a function of the amount of resources produced. For example, under the formula, each block may represent or correspond to a fixed amount (e.g., 1 gallon) of the resources. For a batch of 25,000 gallons, the resource calculator 342 may determine that 25,000 blocks are to be requested. In some embodiments, the resource calculator 342 may determine the number of blocks as a function of the amount of resources, the density, and the environmental impact attribute. For instance, under the formula, each block may represent to a fixed amount of resources, weighed by the estimated emission intensity. Upon determination, the transfer handler 340 may include the number of blocks in the request 348. The transfer handler 340 may transmit the request 348 to the producer device 302.

The blockchain manager 330 executing on the producer device 302 may retrieve, identify, or otherwise receive the request 348 from the recipient device 304. Upon receipt, the blockchain manager 330 may parse the request 348 to extract or identify various parameters included therein. From the request 348, the blockchain manager 330 may identify: the amount of requested resources; other attributes for the resource; the identifier for the recipient entity; and the type of environmental impact, among others. In some embodiments, the blockchain manager 330 may commence to associate the number of blocks as identified in the request 348 to the recipient entity. In some cases, the number of blocks may have been generated prior to the receipt of the request. In other cases, the number of blocks may be generated in response to the request 348. The generation of the blocks may be in a similar manner as described in system 200.

In some embodiments, the blockchain manager 330 may invoke the batch evaluator 328 to determine the number of blocks to associate with the recipient entity of the recipient device 304 based on the request 348. The batch evaluator 328 executing on the producer device 302 may calculate or determine the number of blocks to provide for request 348. The determination of the number of blocks may be in response to the invocation. In some embodiments, the batch evaluator 328 may calculate the number of blocks as a function of the amount of resources produced. For example, under the formula, each block may represent or correspond to a fixed amount (e.g., 1 gallon) of the resources. For a batch of 25,000 gallons, the batch evaluator 328 may determine that 25,000 blocks are to be requested. In some embodiments, the batch evaluator 328 may determine the number of blocks as a function of the amount of resources, the density, and the environmental impact attribute. For instance, under the formula, each block may represent to a fixed amount of resources, weighed by the estimated emission intensity.

In response to the request 348, the blockchain manager 330 may select or identify a subset of blocks 336a-n (hereinafter generally referred to as blocks 336). corresponding to the number of blocks from the blockchain 312. In some embodiments, the blockchain manager 330 may set or identify at least one set 334a-n (hereinafter generally referred to as a set 334) from which blocks 336 are to be assigned to the recipient entity. In some cases, the request 348 may identify the type of environmental impact, for example, as one of direct (e.g., Scope 1 emissions) or indirect (e.g., Scope 3 emissions), among others. The blockchain manager 330 may select or identify the set 334 corresponding to the type of environmental impact as identified in the request 348. For example, the first set 334a may include blocks 336 for the direct environmental impact and the second set 334b may include blocks 336 for the indirect environmental impact. In this scenario, when the request 348 is for direct environmental impact, the blockchain manager 330 may select the first set 334a. Conversely, when the request 348 is for indirect impact, the blockchain manager 330 may select the second set 334b. In some cases, the request 348 may lack any identification of the type of environmental impact. When the request 348 does not specify the type of environmental impact, the blockchain manager 330 may identify the subset of blocks 336 from both sets 334a and 334b. The identified blocks 336 in one set 334 may correspond to the blocks 336 in the other set 334, with the same batch-related attributes.

With the identification, the blockchain manager 330 may assign, transfer, or otherwise associate the number of blocks to the recipient entity of the recipient device 304. Each block 336 may have a wallet identifier corresponding to the producer device 302, indicating that the represented unit of resources are newly registered. In each block 336 of the given set 334, the blockchain manager 330 may set, change, or otherwise update the wallet identifier in the block 336 to the wallet identifier of the blockchain wallet of the recipient entity. The updating of the blocks 336 may be in accordance with blockchain protocols, and may entail updating of other data within the blocks 336, such as the hash values among others. In some embodiments, while newly minting each block 336, the blockchain manager 330 may include the wallet identifier for the recipient entity into the block 336. By setting the wallet identifier in each identified block b to that of the recipient entity, the ownership or association of the block 336 may be transferred to the recipient entity.

The blockchain manager 330 may return, send, or otherwise transmit at least one notification 350 to the recipient device 304. The notification 350 may indicate, identify, or otherwise confirm that the recipient entity (e.g., the consumer entity or the distributor entity) has bene associated with the subset of blocks 336. The subset of blocks 336 may be from multiple sets 334, such as both sets 334a and 334b when the request 348 lacked identification of the type of environmental impact. In some cases, the set of blocks 336 may be from the set 334 for the type of environmental impact as identified in the request 348. The notification 350 may include an identification of each block 336, for example, using the unique token identifier. In some embodiments, the blockchain manager 330 may send the notification to the recipient device 302, upon completion of the transfer of association of the blocks 336 to the recipient entity.

The transfer handler 340 may retrieve, identify, or otherwise receive the notification 350 from the producer device 302. Upon receipt, the transfer handler 340 may provide the user interface 346 to update one or more blocks 336 now associated with the recipient entity of the recipient device 302. The user interface 346 may include user interface elements used to retrieve or receive one or more inputs to update the blocks 336. The updating of the blocks 336 may be to set the claim status as claimed, consumed, or otherwise untradeable. The updating of the blocks 336 may be to transfer ownership or association of the blocks 336 to another entity or another wallet associated with the same recipient entity.

The inputs may include, for example: amount of resources to be consumed or claimed; token identifiers for individual blocks 336; number of blocks 336 to be claimed; attributes for the resources as represented by the blocks 336 to be claimed; an identifier for the next recipient entity or wallet; or type of environmental impact for the blocks 336 to be claimed, among others. In some embodiments, the inputs may be the same as the inputs used to generate the request 348. In some embodiments, the inputs may differ and may be received separately subsequent to the receipt of the notification 350. When the inputs include the portion of the amount of resources, the transfer handler 340 may invoke the resource calculator 342 in a similar manner as described above to determine the number of blocks to be consumed. With the receipt of the inputs, the transfer handler 340 may invoke the blockchain manager 344 to update the blocks 336 in the blockchain 312.

FIG. 3B illustrates a block diagram of the blockchain 312 including sets 334a and 334b of blocks 336 and 336′ upon updating. Using the inputs, the blockchain manager 344 on the recipient device 304 may identify the subset of blocks 336 (or 336′) to be updated. For example, when the inputs identify individual token identifiers, the blockchain manager 344 may identify or select the subset of blocks 336 corresponding to the blocks 336. When the inputs identify the number of blocks, the blockchain manager 344 may identify the subset of blocks 336 from the blockchain 312 totaling the number of blocks. The number of blocks may correspond to the portion of the amount of resources to be claimed.

When the inputs identify the type of environmental impact, the blockchain manager 344 may select or identify the set 334 corresponding to the identified type of environmental impact from which the blocks 336 are to be updated. For example, if the type is direct impact, the blockchain manager 344 may select the first set 334a including the blocks 336 corresponding to the direct environmental impact. Conversely, if the type is indirect impact, the blockchain manager 344 may select the second set 334b including the blocks 336′ corresponding to the indirect environmental impact. With the identification of the set 334a or 334b, the blockchain manager 334 may identify or select the blocks 336 to be updated. On the other hand, if neither are specified, the blockchain manager 344 may identify blocks 336 from both sets 334a and 334b that correspond to each other.

With the identification of each block 336, the blockchain manager 344 may update the block 336 in accordance with the inputs. The inputs may define that the update of the blocks 336 may be to change the claim status. To update the block 336 in the given set 334, the blockchain manager 344 may execute the smart contract of the blockchain 312. In some embodiments, the blockchain manager 344 may execute the smart contract included in each block 366 to update the claim status. From executing the smart contract, the blockchain manager 344 may change, set, or otherwise configure the claim status of the blocks 366 to claimed. By setting the claim status to claimed, the blocks 366 may become untradeable with the other entities. Furthermore, the blocks 336 in one set 334 can be claimed and updated, without claiming or updating the corresponding blocks 336 in the other set 334. In the depicted example, the first and second blocks 336a and 336b in the first set 334a may be claimed and updated, while the corresponding first and second blocks 336′a and 336′b in the second set 334b remain unchanged.

With the updating of the claim status, the blockchain manager 334 may update the blocks 366 to place, move, or otherwise transfer from the original blockchain wallet of the recipient entity to a burn wallet of the blockchain 312. When placed in the burn wallet, the blocks 366 may be no longer tradeable with other entities of the system 300. In some embodiments, the blockchain manager 334 may send, broadcast, or transmit to the other computing devices that the claim status blocks 366 has been changed to claimed. In some embodiments, the blockchain manager 344 may modify, change, or update a tradability attribute stored in a database (e.g., on the network 310) for each updated block 336. The updated tradability attribute may indicate that the block 336 is no longer transferrable beyond the recipient entity associated with the recipient device 302.

In some embodiments, the blockchain manager 334 may update the identified blocks 336 to transfer the ownership or association of the blocks 336. The inputs may include the identifier (e.g., wallet identifier) for the next recipient entity or another wallet for the same recipient entity associated with the recipient device 302. In some embodiments, the blockchain manager 334 may update the blocks 336 in one set 334 to transfer to another wallet, when the claim statuses of the corresponding blocks 336 in the other set 334 are updated to be claimed. To carry out the transfer of the block 336 in the given set 334, the blockchain manager 344 may execute the smart contract of the blockchain 312. In some embodiments, the blockchain manager 344 may execute the smart contract included in each block 366. From executing the smart contract, the blockchain manager 344 may change, modify, or otherwise set the wallet identifier of the blocks 366 to the wallet identifier indicated in the inputs. The updating of the blocks 336 may be in accordance with blockchain protocols, and may entail updating of other data within the blocks 336, such as the hash values among others.

In some embodiments, the blockchain manager 344 may generate updated blocks 356a-n (hereinafter generally referred to as updated blocks 356) from performing the update (e.g., to update claim status or to transfer). The updated blocks 356 may identify or include transaction data for the updating of the corresponding block 336. The blockchain manager 344 may generate the transaction data to include each updated block 356 based on the updating itself (e.g., using a value representing the type of update) and the production data from the corresponding original block 336. In some embodiments, the blockchain manager 344 may include a pointer to the transaction data in each updated block 356. The transaction data may be unique to a particular updated block 356. As such, by including the transaction data, the updated blocks 356 may also be non-fungible tokens (NFTs).

Furthermore, the blocks 336 in one set 334 can be updated to generate corresponding updated blocks 356, without updating the corresponding blocks 336 in the other set 334. In the depicted example, the first and second blocks 336a and 336b in the first set 334a (representing Scope 1 tokens) may be updated and updated blocks 356a and 356b may be generated for the blocks 336a and 336b respectively. The corresponding first and second blocks 336′a and 336′b in the second set 334b remain unchanged. Conversely, the third block 336′c in the second set 334b (representing Scope 3 token) may be updated and updated blocks 356′c may be generated for the block 356c respectively. The updated blocks 356a and 356b may be associated with the first set 334a and the updated block 356′c may be associated with the second set 334b.

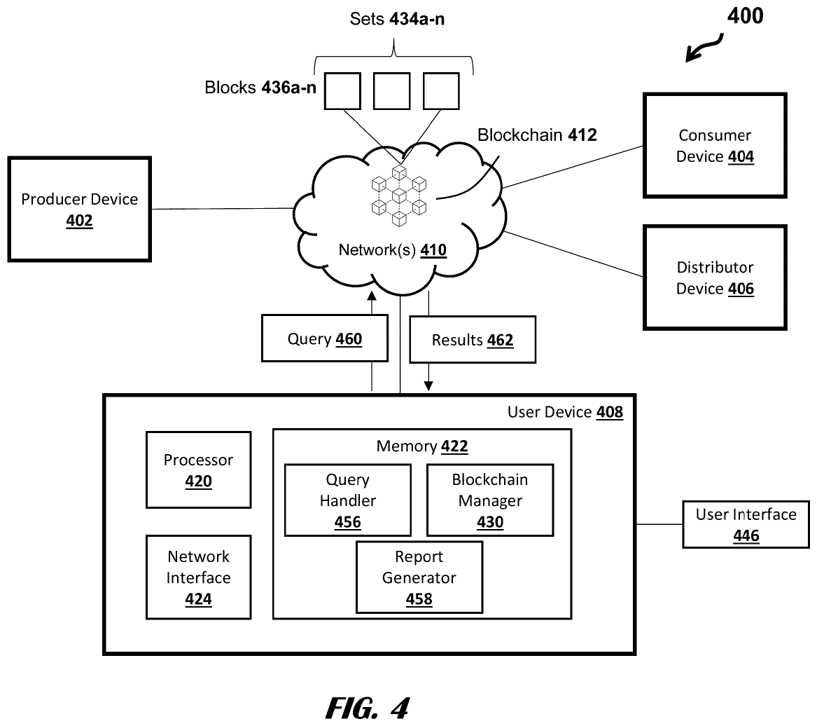

FIG. 4 illustrates a block diagram of a system 400 for accessing blocks for tracking resource production and sustainability. In overview, the system 400 may include at least one producer device 402, at least one consumer device 404, at least one distributor device 406, and at least one user device 408, communicatively coupled with one another over one or more networks 410. The user device 408 may include processor 420, memory 422, and at least one network interface 424. The memory 422 may store, maintain, or otherwise include instructions to run at least one blockchain manager 430, at least one query handler 456, at least one report generator 458, among others. The processor 420 may perform or carry out operations performed by the user device 408, such as those stored on the memory 422. The network interface 424 may include one or more components, such as a transmitter, receiver, or network interface card (NIC), to communicatively couple the consumer device 408 with the network 410.

Embodiments may comprise additional or alternative components or omit certain components from those of FIG. 4 and still fall within the scope of this disclosure. Various hardware and software components of one or more public or private networks may interconnect the various components of the system 400. Each component in system 400 may be any computing device comprising one or more processors coupled with memory and software and capable of performing the various processes and tasks described herein.

The query handler 456 executing on the user device 408 may produce, output, or otherwise generate at least one query 460 to obtain information on the blocks 436 across one or more sets 434 of the blockchain 412. In some embodiments, the query 460 may be for a general report of the blocks 436 in the blockchain 412. In some embodiments, the query 460 may include specifications to compare against the transaction data of the blocks 436. To generate, the query handler 456 may display, provide, or otherwise present at least one user interface 446. The user interface 446 may be a graphical user interface (GUI) rendered on a display of the recipient device 304. The GUI may include one or more user interface elements to enter various parameters in relation to the query 460. The user interface elements of the GUI may include, for example, text boxes, radio buttons, check boxes, and sliders, among others for indicating the values of the corresponding parameters. The user interface 446 may retrieve, obtain, or otherwise receive one or more user inputs identifying the parameters. The user inputs entered for the user interface 346 may be received through use of a gesture recognition system, a keyboard, a stylus, a mouse, or any other input/output (I/O) device of the user device 408.

Via the interface 446, the query handler 456 may retrieve, identify, or receive the one or more inputs. The inputs may include or identify individual token identifiers for the blocks 436; identifiers for various entities in the system 400, such as the producer, consumer, and distributor entities; and status identifier corresponding to one or claimed (or retired) or unclaimed. The inputs may include other attributes for the resource, such as: a feedstock type; a feedstock location; a feedstock production pathway; a blend percentage; a density of resources; certificate-related information; and environmental impact attributes, among others. In some embodiments, the inputs may a type of environmental impact, such as direct impact (e.g., Scope 1 emissions) or indirect impact (e.g., Scope 3 emissions), among others. With the inputs, the query handler 456 may include the inputs as specifications of the query 460. The query handler 456 may provide, send, or otherwise the query 460 to the computing devices coupled with the network 410 or the blockchain manager 430 on the same user device 408.

The blockchain manager 430 executing on the user device 408 (or other computing devices in the system 400) may access the blockchain 412 using the query 460 to generate query results. The query b may be for general report of the blockchain 412. From accessing, the blockchain manager 430 may count, determine, or identify various characteristics about the blockchain 412, such as: the number of blocks by wallet identifier or entity; number of registered blocks; number of owned blocks (e.g., associated with another entity besides the producer entity); number of non-transferred blocks (e.g., owned by the producer entity); number of transferred blocks; and number of retired blocks; among others.

In some embodiments, the blockchain manager 430 may compare the specifications of the query 460 with the data (e.g., the transaction data or unique token identifier) in each block 436. In some embodiments, the blockchain manager 430 may select at least one set 434 containing the blocks 436 to compare against the specifications of the query 460. When the query 460 specifies for direct environmental impact, the blockchain manager 430 may identify the corresponding set 434 (e.g., the first set 434a). When the query 460 specifies for indirect environmental impact, the blockchain manager 430 may identify the corresponding set 434 (e.g., the second set 434b). When the query 460 lacks any specification, the blockchain manager 430 may identify all the sets 434 including blocks 436 to compare against.

From comparing with each block 436, the blockchain manager 430 may determine whether the data of the block 436 matches or satisfies the specifications of the query 460. When the data is determined to satisfy the specifications of the query 460, the blockchain manager 430 may identify the block 436 for inclusion in generating a result for the query 460. In some embodiments, the blockchain manager 430 may maintain a counter for the type of specification in the query 460 and update the counter upon matching. For example, the blockchain manager 430 may maintain a counter for number of blocks by wallet identifier, unclaimed status, and claim status, among others. In some embodiments, the blockchain manager 430 may identify various information about each block 436 upon determining that the block 436 is to be included for generating the results. The information may include transaction data, token identifier, and the transfer history of each block 436 identified as satisfying the specifications (e.g., token identifier), among others. In contrast, then the data is determined to not satisfy the specifications of the query 460, the blockchain manager 430 may identify the block 436 for exclusion in generating the result in the query 460.

The report generator 458 executing on the user device 408 may produce, output, or generate at least one result 462 for the query 460. With the identification of the blocks 436 for inclusion, the report generator 458 may generate the result 462. The result 462 may identify or include, for example, one or more of the following: the number of blocks by wallet identifier or entity; number of registered blocks; number of owned blocks (e.g., associated with another entity besides the producer entity); number of non-transferred blocks (e.g., owned by the producer entity); number of transferred blocks; and number of retired blocks; and information about the blocks 436 satisfying the query 460 (e.g., the token identifier, transaction data, and transfer history), among others. Upon generation, the report generator 458 may display, provide, or otherwise present the results 462 via the user interface 446.

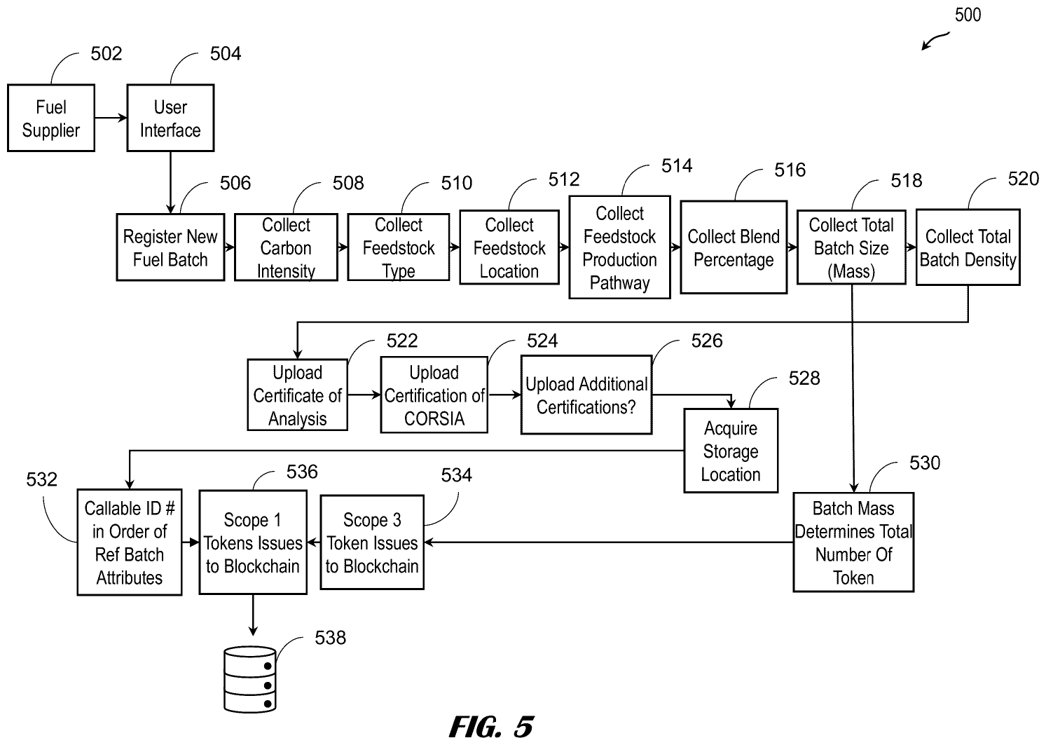

FIG. 5 illustrates a flow diagram of a process 500 of generating blocks for a blockchain. Embodiments may include additional, fewer, or different operations than those described in the process 500. The process 500 is performed by a computing device, though it should be appreciated that one or more computing devices or processors may perform the various operations described above. At step 502, a fuel supplier process may be initiated. At step 504, a computing device may present a user interface. At step 506, the computing device may commence registration of a fuel batch. At 508, the computing device may collect a carbon intensity. At step 510, the computing device may collect feedstock type. At step 512, the computing device may collect feedstock location. At 514, the computing device may collect feedstock production pathway. At step 516, the computing device may collect blend percentage. At step 518, the computing device may collect total batch size (or mass). At step 520, the computing device may collect a total batch density.

Continuing on, at step 522, the computing device may upload a certificate of analysis. At step 524, the computing device may upload a certification of CORSIA. At step 526, the computing device may upload additional certifications. At step 528, the computing device may determine the storage location of certificates according to, for example, preconfigured settings or pointer information in one or more blocks of the blockchain. In conjunction, at step 530, the computing device may calculate batch mass to determine a total number of tokens to be generated. At step 532, the computing device may identify a callable identifier for the fuel batch. At step 534, the computing device may generate Scope 3 tokens to issue to a blockchain. At step 536, the computing device may generate Scope 1 tokens to issue to the blockchain. At step 538, the computing device may broadcast the tokens for the blockchain.

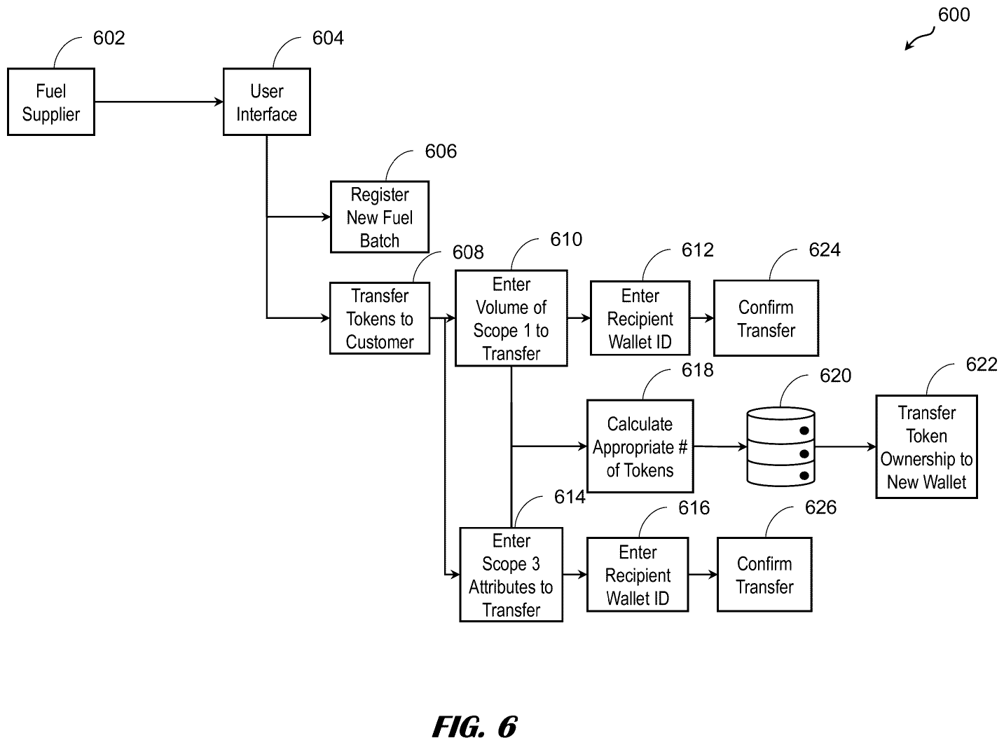

FIG. 6 illustrates a flow diagram of a process 600 of transferring ownership of blocks in a blockchain. Embodiments may include additional, fewer, or different operations than those described in the process 600. The process 600 is performed by a computing device, though it should be appreciated that one or more computing devices or processors may perform the various operations described above. At step 602, a fuel supplier process may be initiated. At step 604, the computing device may present a user interface. At step 606, the computing device may have registered a new fuel batch. At step 608, the computing device may commence a process to transfer tokens.

Furthermore, at step 610, the computing device may receive entry of a volume of Scope 1 tokens to transfer. In some cases, when retiring or transferring fuel, the user may specify the volume and/or indicate from which batches of fuel the user wants to transfer. As such, the entry need not be limited the volume entry, and may further include indications for selecting the tokens or claims the user wants to transfer. At step 612, the computing device may receive entry of a recipient wallet identifier. In conjunction, at step 614, the computing device may receive entry of a volume of Scope 3 tokens to transfer. At step 616, the computing device may receive entry of a recipient wallet identifier. At step 618, the computing device may calculate the appropriate number of tokens to transfer based on the volume. At step 620, the computing device may access the blockchain. At step 622, the computing device may transfer the token ownership to the new wallet. At step 624, the computing device may confirm the transfer of Scope 1 tokens. At step 626, the computing device may confirm the transfer of Scope 3 tokens.

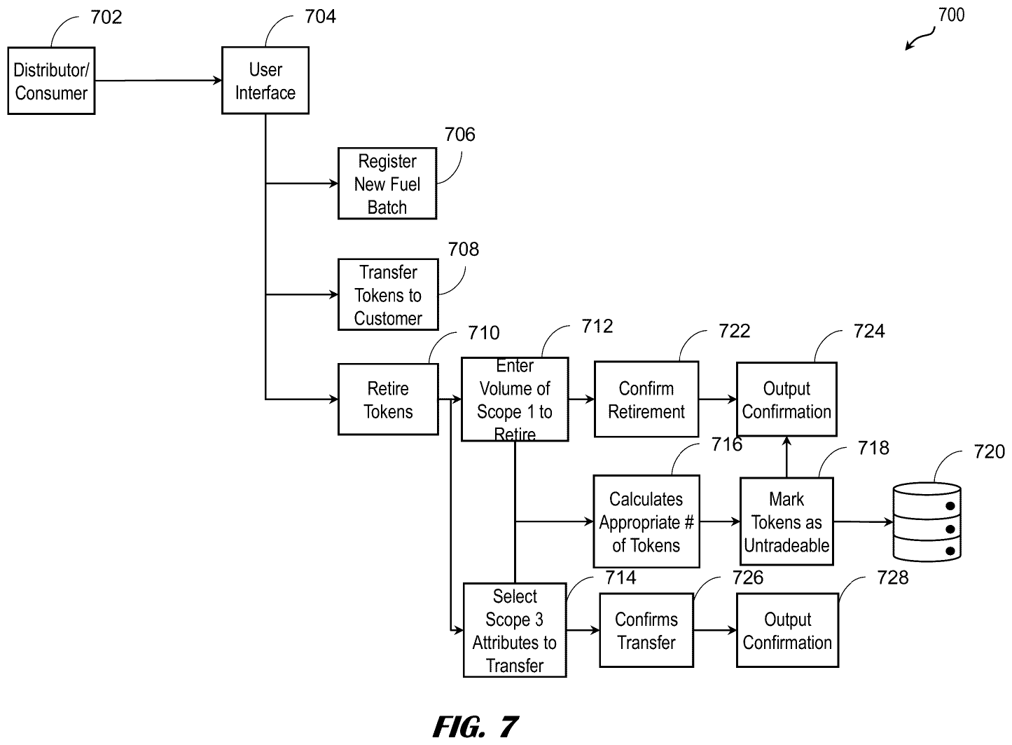

FIG. 7 illustrates a flow diagram of a process 700 of claiming tokens in a blockchain (e.g., user indicates ownership, user retires or transfers). Embodiments may include additional, fewer, or different operations than those described in the process 700. The process 700 is performed by a computing device, though it should be appreciated that one or more computing devices or processors may perform the various operations described above. At step 702, a distributor/consumer process may be initiated. At step 704, a computing device may present a user interface. At step 706, the computing device may have registered a new fuel batch. At step 708, the computing device may have transferred tokens to the consumer. At step 710, the computing device may initiate a process to retire at least a portion of the tokens.

Continuing on, at step 712, the computing device may receive entry of scope 1 volume to retire. At step 714, the computing device may receive selection of scope 3 attributes to transfer. At step 716, the computing device may calculate the appropriate number of tokens. At step 718, the computing device may mark the tokens as untradeable. At step 720, the computing device may update the blockchain. At step 722, the computing device may confirm retirement. At step 724, the computing device may output the confirmation of retirement. At step 726, the computing device may confirm the transferal of the tokens. At step 728, the computing device may output the confirmation of the transfer.

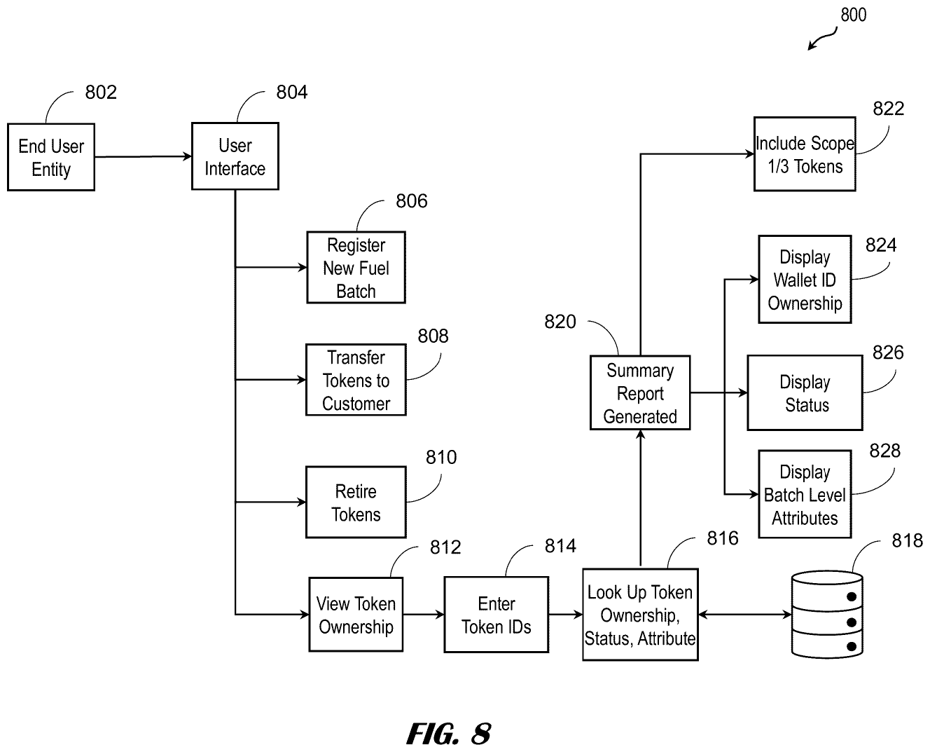

FIG. 8 illustrates a flow diagram of a process 800 of accessing tokens of a blockchain. Embodiments may include additional, fewer, or different operations than those described in the process 800. The process 800 is performed by a computing device, though it should be appreciated that one or more computing devices or processors may perform the various operations described above. At step 802, an end user entity related process may be initiated. At step 804, the computing device may present a user interface. At step 806, the computing device may have registered a new fuel batch. At step 808, the computing device may have transferred tokens to the customer. At step 810, the computing device may have retired tokens. At step 812, the computing device may initiate a view token ownership process.

With the initiation, at step 814, the computing device may receive entry of token identifiers. At step 816, the computing device may look up token ownership, status, and attributes. At step 818, the computing device may access a blockchain. At step 820, the computing device may generate a summary report. At step 822, the computing device may include scope 1 and 3 tokens. At step 824, the computing device may display a wallet identifier for the ownership. At step 826, the computing device may display the status for each token. At step 828, the computing device may display batch level attributes.

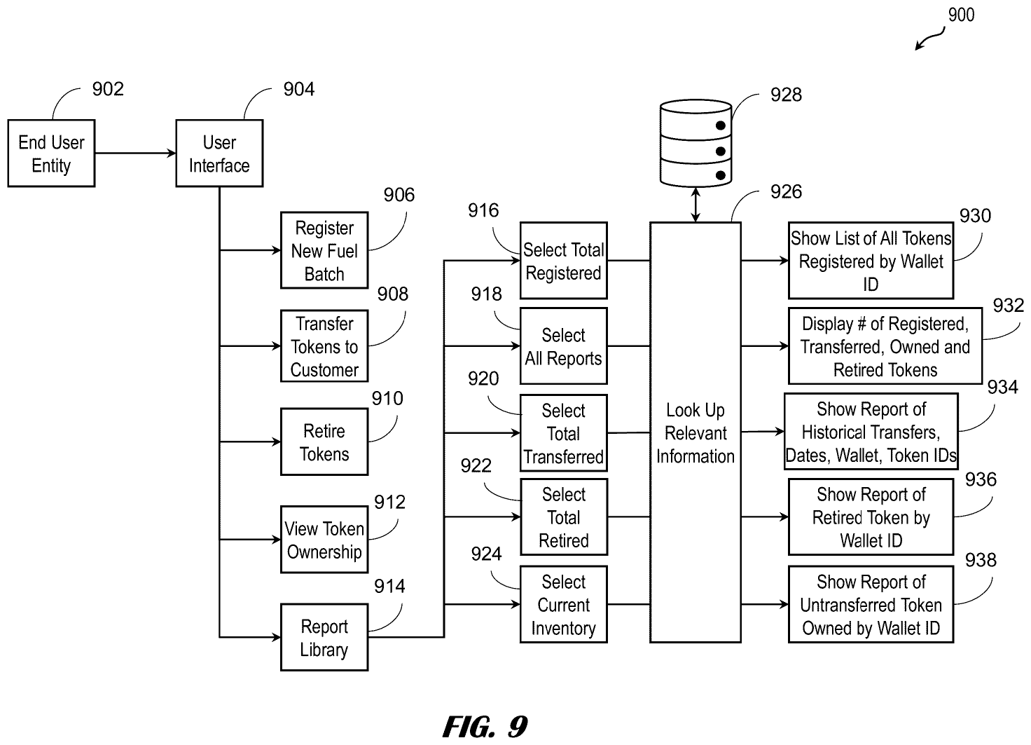

FIG. 9 illustrates a flow diagram of a process 900 of querying tokens of a blockchain. Embodiments may include additional, fewer, or different operations than those described in the process 900. The process 900 is performed by a computing device, though it should be appreciated that one or more computing devices or processors may perform the various operations described above. At step 902, an end user entity related process may be initiated. t step 904, the computing device may present a user interface. At step 906, the computing device may have registered a new fuel batch. At step 908, the computing device may have transferred tokens to the customer. At step 910, the computing device may have retired tokens. At step 912, the computing device may have performed a view token ownership process.

At step 914, the computing device may initiate a library report process. At step 916, the computing device may select a total registered tokens. At step 918, the computing device may select one or more reports. At step 920, the computing device may select a total number of transferred tokens. At step 922, the computing device may select a total number of retired tokens. At step 924, the computing device may select a current inventory of tokens. At 926, the computing device may perform a look up relevant information. At step 928, the computing device may access the blockchain for the look up. At step 930, the computing device may show a list of all tokens registered by wallet identifier. At step 932, the computing device may display a number of registered, transferred, owned, and retired tokens. At step 934, the computing device may show a report of historical transfers, dates, wallets, and token identifiers. At step 936, the computing device may show a report of retired tokens by wallet identifiers. At step 938, the computing device may show a report of non-transferred tokens owned by wallet identifiers.

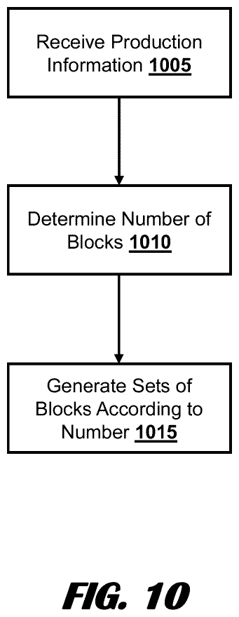

FIG. 10 illustrates a flow diagram of a method 1000 of generating blocks for blockchain-based tracking of resource production and sustainability. Embodiments may include additional, fewer, or different operations than those described in the method 1000. The method 1000 is performed by a computing device, though it should be appreciated that one or more computing devices or processors may perform the various operations described above.

In step 1005, a computing device may receive production information. The production information may be for a batch of resources to be registered. The production information may identify or include a batch identifier for the resources produced, a total amount of the resources to be registered, and an identifier of each recipient entity to receive at least a portion of the batch of resource, among others. In some embodiments, the production information may identify one or more attributes of the resource, such as environmental attributes and certificate information. The production information may be inputted via a user interface presented on the computing device.

In step 1010, the computing device may determine a number of blocks. The determination of the number of blocks may be based on the production information. Each block may represent a unit of resources to be registered. The computing device may calculate the number of blocks as a function of the total amount of resources. In some embodiments, the computing device may determine the number of blocks as a function of various parameters in the production information.

In step 1015, the computing device may generate one or more sets of blocks in accordance with the determined number. The computing device generates the blocks in accordance with a blockchain protocol. Each block may be unique from one another. Each block may include a unique token identifier and at least a portion of the production information. In some embodiments, each block may include a pointer to a location on which the portion of the production information (e.g., certificate related information) is stored. The computing device may generate blocks for one set corresponding to a direct environmental impact (e.g., Scope 1 emissions) and corresponding block for another corresponding to an indirect environmental impact (e.g., Scope 3 emissions). Initially, the ownership of the blocks may be associated with the entity that registered the batch of resources, and a status of the blocks may be indicated as unclaimed. Upon generation, the computing device may add the block to the blockchain.

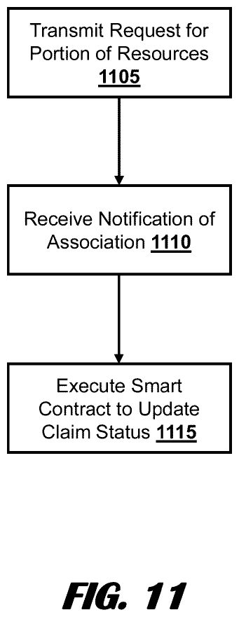

FIG. 11 illustrates a flow diagram of a method 1100 of claiming blocks for blockchain-based tracking of resource production and sustainability. Embodiments may include additional, fewer, or different operations than those described in the method 1100. The method 1100 is performed by a computing device, though it should be appreciated that one or more computing devices or processors may perform the various operations described above.

In step 1105, a computing device may transmit a request for a portion of resources. The computing device may generate the request for the portion of resources using inputs entered via a user interface. The request may include or identify the amount of resources to be transferred to the recipient entity, number of blocks to be transferred, an identifier for the recipient entity (e.g., a wallet identifier), or attributes for the amount of resources, among others. The request may also specify a type of environmental impact, such as direct or indirect. The request may be transmitted to another computing device to which the blocks are assigned.

In step 1110, the computing device may receive a notification of association. The notification may indicate that the entity associated with the computing device has been assigned the blocks as identified in the request. The number of blocks identified in the notification may represent the amount of requested resources. The notification may include an identifier for each block and an indication that the blocks are transferred to a blockchain wallet of the entity.

In step 1115, the computing device may execute the smart contract to update the status. The computing device may update a claim status by executing the smart contract of the block chain. The claim status may initially be set to unclaimed, and by updating the claim status may be changed to claimed. Upon changing the status, the computing device may transfer the association of the blocks to another wallet (e.g., a burn wallet). The computing device may update the claim statuses of blocks in one set, while maintaining the statuses of the blocks in the other set.

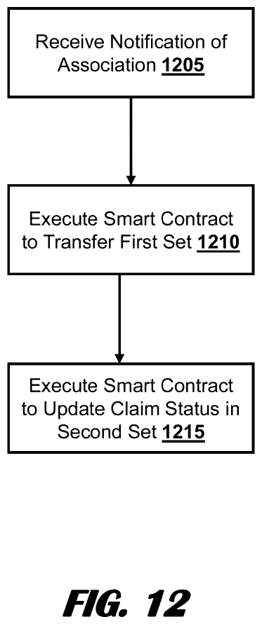

FIG. 12 illustrates a flow diagram of a method 1200 of updating blocks for blockchain-based tracking of resource production and sustainability. Embodiments may include additional, fewer, or different operations than those described in the method 1200. The method 1200 is performed by a computing device, though it should be appreciated that one or more computing devices or processors may perform the various operations described above.

In step 1205, a computing device may receive a notification of association. The notification may indicate that the entity associated with the computing device has been assigned the blocks as identified in a request for the amount of resources. The number of blocks identified in the notification may represent the amount of requested resources. The notification may include an identifier for each block and an indication that the blocks are transferred to a blockchain wallet of the entity. The blocks may be from both sets, one corresponding to a direct environmental impact (e.g., Scope 1 emissions) and another corresponding to an indirect environmental impact (e.g., Scope 3 emissions).

In step 1210, the computing device may execute a smart contract to transfer a first set of blocks. The first set of blocks may correspond to one of the direct or indirect environmental impact. For the first set of blocks, the computing device may execute the smart contract to transfer ownership or association to another blockchain wallet. The transferal may be to allow for additional, subsequent trading of the blocks and by extension the units of resources represented by the blocks.

In step 1215, the computing device may execute a smart contract to update a claim status in a second set of block. The second set of blocks may correspond to one of the direct or indirect environmental impact, and may differ from the first set of blocks. The computing device may update a claim status by executing the smart contract of the block chain. The claim status may initially be set to unclaimed, and by updating the claim status may be changed to claimed. Upon changing the status, the computing device may transfer the association of the blocks to another wallet (e.g., a burn wallet).

### Example Embodiments

Aspects of the present disclosure are directed to systems and method for blockchain based tracking resource production and sustainability. A producer computer of a plurality of computers associated with a blockchain may receive production information indicating an amount of a resource produced, a batch identifier for the resource produced, and a plurality of wallet identifiers for a corresponding plurality of resource recipients. The producer computer may determine a number of blocks for the blockchain to generate for representing a unit of the resource produced of the amount of resource produced. The producer computer may generate a plurality of blocks on the blockchain according to the number of blocks and using the production information. The plurality of blocks may include a plurality of sets of blocks for a corresponding resource recipient of the plurality of resource recipients. Each block in the set of blocks for the corresponding resource recipient including a wallet identifier for the resource recipient.

In some embodiments, each block may include a pointer to a non-transitory storage medium containing at least a portion of the production information.

In some embodiments, the set of blocks for the resource recipient may include a first subset of [scope 1] blocks and a corresponding second subset of [scope 3] blocks.

In some embodiments, the producer computer may receive one or more user inputs containing the production information via a user interface of the producer computer.

In some embodiments, a set of one or more blocks includes a digital record including data defining a physical and sustainability profile of a physical commodity represented by the digital record.

Other aspects of the present disclosure are directed to systems and methods for blockchain-based tracking resource production and sustainability. A consumer computer associated with a consumer of a plurality of computers associated with a blockchain, may transmit, to a producer computer of the plurality of computers a request for a portion of an amount of a resource. The consumer computer may receive a notification confirming that a blockchain wallet of the consumer has been associated with a set of blocks added to the blockchain, the set of blocks representing the portion of the amount of the resource. The consumer computer may, in response to the consumer computer receiving one or more user inputs for updating a claim status of the portion of the amount of resource represented by the set of blocks, execute a smart contract of the blockchain configured to update the set of blocks to being untradeable.

In some embodiments, the consumer computer executing the smart contract may update the set of blocks to indicate a transfer from the blockchain wallet of the consumer to a burn wallet of the blockchain.

In some implementations, updating the set of blocks as untradeable includes updating, by the consumer computer executing the smart contract, the set of blocks to indicate a transfer from the blockchain wallet of the consumer to an unusable pointer address.

In some embodiments, the consumer computer executing the smart contract, a tradability attribute stored in a database for each block of the set of blocks.

Other aspects of the present disclosure are directed to systems and methods for blockchain-based tracking resource production and sustainability. A computer of a plurality of computers associated with a blockchain may receive a notification confirming that a first blockchain wallet has been associated with a first set of [scope 1] blocks and a second set of [scope 3] blocks added to the blockchain. The first set of blocks may represent an amount of a resource. The computer may execute a first smart contract of the blockchain configured to transfer the second set of blocks to a second blockchain wallet. The computer may execute a second smart contract of the blockchain configured to update the first set of blocks to being untradeable in response to receiving an update to a claim status for the resource represented by the first set of blocks.

In some implementations, a portion of the first set of blocks or the second set of blocks correspond to consumed fuel.

In some embodiments, a system comprises one or more computing devices configured as nodes of a blockchain. A first computing device comprising a processor configured to: immutably store on one or more blocks of the blockchain environmental and performance characteristics of a physical fuel, wherein the environmental and performance characteristics of the physical fuel indicate a plurality of supply chain types.

In some implementations, the one or more nodes are configured to merge the emission accounting from a mass balance physical inventory with the accounting for a book and claim program

In some implementations, the one or more nodes are configured to store additional blocks on the blockchain indicating environmental claims from at least one of physical consumption or virtual consumption according to a claim received from the computer.

In some implementations, a set of one or more nodes includes a digital record including data defining a physical and sustainability profile of a physical commodity represented by the digital record.

In some implementations, the first computing device is configured to generate and store a summary reporting associated with one or more tokens for an environmental program compliance, the summary reporting including sustainability information based upon a physical and sustainability profile data for one or more physical resources.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for blockchain-based tracking resource production and sustainability, the method comprising:
receiving, by a producer computer of a plurality of computers associated with a blockchain, production information indicating an amount of a resource produced, a batch identifier for the resource produced, and a plurality of wallet identifiers for a corresponding plurality of resource recipients;
determining, by the producer computer, a number of blocks for the blockchain to generate for representing a unit of the resource produced of the amount of resource produced;
generating, by the producer computer, a plurality of blocks on the blockchain according to the number of blocks and using the production information, the plurality of blocks including a plurality of sets of blocks for a corresponding resource recipient of the plurality of resource recipients, each block in the set of blocks for the corresponding resource recipient including a wallet identifier for the resource recipient.

2. The method according to claim 1, further comprising generating, by the producer computer, a graphical user interface indicating ownership of one or more units of the resource produced.

3. The method according to claim 1, wherein each block includes a pointer to a non-transitory storage medium containing at least a portion of the production information.

4. The method according to claim 1, wherein the set of blocks for the resource recipient includes a first subset of blocks and a corresponding second subset of blocks.

5. The method according to claim 1, wherein the producer computer receives one or more user inputs containing the production information via a user interface of the producer computer.

6. The method according to claim 1, wherein a set of one or more blocks includes a digital record including data defining a physical and sustainability profile of a physical commodity represented by the digital record.

7. A computer-implemented method for blockchain-based tracking resource production and sustainability, the method comprising:
transmitting, by a consumer computer associated with a consumer of a plurality of computers associated with a blockchain, to a producer computer of the plurality of computers a request for a portion of an amount of a resource;
receiving, by the consumer computer, a notification confirming that a blockchain wallet of the consumer has been associated with a set of blocks added to the blockchain, the set of blocks representing the portion of the amount of the resource; and
in response to the consumer computer receiving one or more user inputs for updating a claim status of the portion of the amount of resource represented by the set of blocks, executing, by the consumer computer, a smart contract of the blockchain configured to update the set of blocks to being untradeable.

8. The method according to claim 7, further comprising generating, by the consumer computer, a graphical user interface indicating each block associated with the blockchain wallet of the consumer being indicated as untradeable.

9. The method according to claim 8, further comprising obtaining, by the consumer computer, a computer file for the portion of the amount of resource indicated by a block indicated as being untradeable, the computer file including a sustainability attribute associated with the portion of the amount of resource.

10. The method according to claim 7, wherein updating the set of blocks as untradeable includes updating, by the consumer computer executing the smart contract, the set of blocks to indicate a transfer from the blockchain wallet of the consumer to a burn wallet of the blockchain.

11. The method according to claim 7, wherein updating the set of blocks as untradeable includes updating, by the consumer computer executing the smart contract, the set of blocks to indicate a transfer from the blockchain wallet of the consumer to an unusable pointer address.

12. The method according to claim 7, wherein updating the set of blocks as untradeable includes updating, by the consumer computer executing the smart contract, a tradability attribute stored in a database for each block of the set of blocks.

13. A computer-implemented method for blockchain-based tracking resource production and sustainability, the method comprising:
receiving, by a computer of a plurality of computers associated with a blockchain, a notification confirming that a first blockchain wallet has been associated with a first set of blocks and a second set of blocks added to the blockchain, the first set of blocks representing an amount of a resource;
executing, by the computer, a first smart contract of the blockchain configured to transfer the second set of blocks to a second blockchain wallet; and
executing, by the computer, a second smart contract of the blockchain configured to update the first set of blocks to being untradeable in response to receiving an update to a claim status for the resource represented by the first set of blocks.

14. The method according to claim 13, wherein a portion of the first set of blocks or the second set of blocks correspond to consumed fuel.

15. The method according to claim 13, further comprising generating, by the computer, a graphical user interface indicating each block associated with the second blockchain wallet being indicated as untradeable.

16. A system comprising:
a database configured to store fuel information on a non-transitory machine-readable storage medium;
one or more computing devices configured as nodes of a blockchain, including a first computing device comprising a processor configured to:
immutably store on one or more blocks of the blockchain environmental and performance characteristics of a physical fuel, wherein the environmental and performance characteristics of the physical fuel indicate a plurality of supply chain types.

17. The system according to claim 16, wherein the one or more nodes are configured to merge the emission accounting from a mass balance physical inventory with the accounting for a book and claim program.

18. The system according to claim 16, wherein the one or more nodes are configured to store additional blocks on the blockchain indicating environmental claims from at least one of physical consumption or virtual consumption according to a claim received from the computer.

19. The system according to claim 16, wherein a set of one or more nodes includes a digital record including data defining a physical and sustainability profile of a physical commodity represented by the digital record.

20. The system according to claim 16, wherein the first computing device is configured to generate and store a summary reporting associated with one or more tokens for an environmental program compliance, the summary reporting including sustainability information based upon a physical and sustainability profile data for one or more physical resources.
